(19) United States
(12) Patent Application Publication
(10) Pub. No.: US 2013/0215362 A1
(43) Pub. Date: Aug. 22, 2013

(54) Method For Evaluating Birefringence Of Adhesive, Method For Designing Adhesive, Method For Producing Adhesive, Adhesive, Polarizing Plate, Liquid Crystal Display Device, Method For Producing Polarizing Plate And Method For Producing Liquid Crystal Display Device

(71) Applicants: Yasuhiro Koike, Yokohama-city (JP); Akihiro Tagaya, Yokohama-city (JP); Sumihisa Oda, Saitama-shi (JP); Takeshi Nagakura, Saitama-shi (JP)

(72) Inventors: Yasuhiro Koike, Yokohama-city (JP); Akihiro Tagaya, Yokohama-city (JP); Sumihisa Oda, Saitama-shi (JP); Takeshi Nagakura, Saitama-shi (JP)

(21) Appl. No.: 13/673,311

(22) Filed: Nov. 9, 2012

Related U.S. Application Data
(63) Continuation of application No. PCT/JP2011/060675, filed on May 10, 2011.

(30) Foreign Application Priority Data
May 10, 2010 (JP) 2010-108682

(51) Int. Cl. G01N 21/23; G06F 19/00; G02B 5/30

(52) U.S. Cl. CPC G01N 21/23; G02B 5/3083; G06F 19/701
USPC 349/62; 356/36; 359/489.07; 156/64; 264/1.1; 156/60; 703/2; 525/199; 525/219; 525/228; 525/223; 525/51; 523/303

(57) ABSTRACT

Methods of evaluating birefringence of an adhesive agent, and of designing and producing an adhesive agent using the evaluation method, as well as adhesive agents produced using these methods. A polarizing plate and a liquid crystal display device using the obtained adhesive agent are proposed, as well as methods for producing the same.

### FIELD OF THE INVENTION

The present invention relates to a method of evaluating birefringence of an adhesive agent used for the bonding of a polarizing plate, a phase-difference film or the like which is a framework-member of a liquid crystal display. In more detail, the present invention relates to a new method of evaluating birefringence for reducing the birefringence of the adhesive agent used for the bonding of the polarizing plate or the like and for effectively repressing “light leakage” which largely damages the display characteristic such as contrast or the like of the liquid crystal display, and a designing method and a producing method of the adhesive agent by using aforesaid evaluation method; and further relates to an adhesive agent produced by aforesaid producing method, a polarizing plate and a liquid crystal display device using this adhesive agent, and a method of producing those objects.

### BACKGROUND OF THE INVENTION

Due to the excellent characteristic thereof, the liquid crystal display is utilized broadly as a liquid crystal television, a monitor of a desktop personal computer, and a display of a mobile apparatus such as a note personal computer, a mobile-phone or the like. In recent years, in particular, popularization and development of the liquid crystal television have been remarkable and a lot of sets of large-size liquid crystal televisions over 40 inches are on sale.

For these liquid crystal televisions, a transmissive liquid crystal panel is used and for the liquid crystal panel thereof, usually, two sheets of polarizing plates are bonded together (see FIG. 8). Then, there is employed a configuration in which these plates are illuminated by backlights from the rear sides.

An ordinary polarizing plate is produced by highly-drawing a film which has polyvinylalcohol including iodine as a main component, by orienting the molecules, and by sandwiching the film between polarizing-plate protection films. Further, as shown in FIG. 8, it is also allowed for the constitution using a phase-difference film to employ a configuration in which the polarizing-plate protection film on the side adjacent to the phase-difference film is omitted and the function of the polarizing-plate protection film is combined with the function of the phase-difference film. There is employed a configuration in which these films are bonded-together mutually by an adhesive agent and further, these films are bonded-together by an adhesive agent on a glass substrate.

Here, it is known that the film, which is used at the center portion of the polarizing plate and which has highly oriented polyvinylalcohol as a main component and includes iodine, shrinks gradually during the usage of the liquid crystal display. The polarizing plate (Here, in case of the constitution using a phase-difference film, the plate is to be referred to as a polarizing plate by including this plate.) is bonded with a glass substrate together as mentioned above.

On the other hand, the glass substrate hardly shrinks even during the usage of the liquid crystal display, so that it becomes a situation in which the adhesive agent for bonding the glass substrate and the film used for the polarizing plate is to be used by being sandwiched between the materials having different shrinkage ratios and a stress occurs in the adhesive agent. Also, since the respective shrinkage ratios of the films to be used are different from one another, it is conceivable that stresses occur also in the adhesive agents to be used among them.

Caused by these stresses, birefringence occurs in an adhesive agent and the polarization state of the polarization from the backlight which passes through the adhesive agent layer will be disturbed. As a result thereof, for example, such as shown in FIG. 9, light leaks when displaying “black”, the place which should be displayed as “black” will be displayed as “gray” to “white”, the contrast lowers remarkably, and in a case in which the lowering degree thereof is large, the picture image cannot be displayed correctly, so that a serious problem occurs as a display. In the present specification, this phenomenon is referred to as “light leakage” and a phenomenon, in which as the result of that light leakage, ununiformity occurs inside the picture screen as shown in FIG. 9, is referred to as “ununiformity phenomenon”.

The ununiformity phenomenon becomes the more remarkable generally in the larger-size liquid crystal display. Therefore, improvement for the ununiformity phenomenon is desired strongly particularly for a large-size liquid crystal television.

In order to improve the ununiformity phenomenon, there have been carried out a number of trials for developing an adhesive agent having low birefringence in which it is more difficult for the birefringence to occur. However, generally, it is difficult to evaluate the birefringence of a polymer which constitutes an adhesive agent and it is in a situation at present that the material designing for making low birefringence is not carried out sufficiently.

For the method of evaluating the birefringence of the polymer, generally, the following three methods are known.

The first method is a method of finding “stress optical coefficient” which is inherent to the kind of the polymer. This is a method of fusing & fiber-forming the polymer continuously, of measuring the birefringence and the stress in a steady state, and of evaluating the birefringence of the polymer by the stress optical coefficient which is the proportional constant thereof.

The second method is a method of finding “inherent birefringence” inherent to the kind of the polymer. When drawing the polymer of a film shape by heating it at a glass-transition temperature or more, the polymer molecules are oriented toward the drawing direction. When cooling this polymer up to the glass-transition temperature or less by a speed of such a degree in which it is insufficient for the polymer molecules to be relaxed completely, the polymer molecules become solidified while maintaining the orientation. For example, in case of polycarbonate, polymethylmethacrylate or the like, when heating & drawing it at the temperature of hundred and several ten degrees or more and cooling it up to the room temperature, there can be obtained a drawn film in which the polymer molecules are oriented. By measuring the birefringence of the polymer film obtained in this manner and the degree of orientation of the polymer molecules, it is possible to find the birefringence at the time of “degree of orientation=1.0 (complete orientation state)” and that is referred to as “inherent birefringence”. By making the comparison of this inherent birefringence, it is possible to evaluate the birefringence of the polymer.

The third method is a method of find “photoelastic coefficient” inherent to the kind of the polymer. Stress is applied to a sample of a solid shaped polymer and the birefringence thereof when elastic distortion occurs is measured. The proportional constant between the obtained birefringence and the stress is referred to as “photoelastic coefficient”. By making the comparison of this photoelastic coefficient, it is possible to evaluate the birefringence of the polymer.

According to these methods, the material-property value of the polymer relating to the birefringence thereof is to be measured. Several technologies for improving the ununiformity phenomenon by focusing attention on the material-property values of these birefringences have been reported until now.

For example, in Patent Document 1, there are described an acrylic-based pressure-sensitive bonding composition for a polarizing plate which is characterized by including a component having positive photoelastic coefficient and a polarizing plate produced by applying this composition.

In the Patent Document 1, crosslinked line-shaped polymer structures of most of the acrylic-based pressure-sensitive bonding agents (=adhesive agents) exhibit negative photoelastic coefficients (stress optical coefficients), so that there is disclosed such a technical idea that a component of a comparatively low molecular mass (preferably, less than 2000) having a positive photoelastic coefficient is to be added in which a birefringence compensation action appears only in a case in which the stress is acted by the shrinkage of the polarizing plate.

In Patent Document 2, there is disclosed an invention relating to a polarizing plate which is a polarizing plate including an adhesive agent layer and which is characterized in that the absolute value of the photoelastic coefficient of aforesaid adhesive agent layer is 500×10⁻¹² (1/Pa) or less. There is disclosed that there can be cited an acrylic-based adhesive agent for the kind of the adhesive agent and further, acrylic ester or methacrylic acid ester whose photoelastic coefficient is positive is used as a monomer.

In Patent Document 3, there is disclosed an invention relating to an optical adhesive sheet characterized in that the absolute value of the photoelastic coefficient at 23° C. and in a condition of a 400 nm measurement wave is 5×10⁻¹¹ (1/Pa) or less and also, the temperature, at which the maximum value of loss tangent (tan δ) is presented, is −20° C. or less.

### PRIOR-ART TECHNICAL DOCUMENTS

### Patent Documents

Patent Document 1: Japanese unexamined PCT patent publication No. 2004-516359
Patent Document 2: Japanese unexamined patent publication No. 2006-259664
Patent Document 3: Japanese unexamined patent publication No. 2009-242633

With regard to the technologies provided by the aforementioned Patent Documents, there are a number of problems and even if utilizing these technologies, it was essentially difficult to solve the ununiformity phenomenon by the light leakage mentioned above sufficiently. This is caused by such a fact that it is generally difficult to measure the birefringence of the adhesive agent by the aforementioned methods.

Specifically, when trying to measure the stress optical coefficient in the first evaluation method mentioned above, the adhesiveness is high, as a matter of course, for the basic characteristic as an adhesive agent and also, there is usually included a crosslink structure, so that it is difficult to carry out the fusion & fiber-forming and it is very difficult to prepare a measurement sample.

Also, in order to measure the degree of orientation of the polymer in aforesaid second evaluation method, generally, a two-color ratio of absorption of a specific wavelength by infrared is to be measured and for that purpose, it is necessary to produce a thin film having a thickness of such a degree from several microns to several ten microns. The adhesive agent is usually very soft, so that it is not possible to maintain the shape as the single body itself and also the drawing thereof is difficult. Further, the glass-transition temperature is usually lower than the room temperature, so that when leaving the adhesive agent as it is at the room temperature by releasing the stress after the drawing thereof, the degree of orientation of the polymer molecules changes along with time. For these reasons, also the measurement of the inherent birefringence is difficult.

With regard also to the photoelastic coefficient in aforesaid third evaluation method, the adhesive agent is very soft and is a viscoelastic body, in which it is also difficult to maintain its own shape, so that when applying a stress, an elastic behavior is not presented basically and if applying the stress, distortion will increase continuously and then, the measurement is difficult. If it is supposedly assumed that the measurement can be achieved, the measurement is limited to a considerably hard type agent within the adhesive agents and it is conceivable that there will be employed a method in which a periodic stress is applied to that agent, the birefringence is measured in a range of a very small distortion, whereby the relation with respect to the stress will be found.

As the problem of this method, there can be cited such a problem that for the adhesive agent having hardness of such a degree in which the shape thereof can be maintained, the adhesive force thereof is very low and therefore, there occur many cases in which the agent drops off from the category of a practical adhesive agent. Also, even if taking a consideration from the behavior of the polymer-molecules, the birefringence under such a very small deformation is essentially different from the cause of the “light leakage” and the “ununiformity phenomenon” mentioned above, and it is conceivable that the adhesive agent designed based on such a birefringence evaluation method cannot accomplish an essential solution of the light leakage. There will be explained this matter in detail hereinafter.

The shrinkage of the polarizing plate which induces the “light leakage” and the “ununiformity phenomenon” mentioned above is −0.5% to −2.0% in the drawing direction of polyvinylalcohol (“Minus” means “shrinkage”. For the shrinkage ratio, the value thereof is 0.5% to 2.0%. See Patent Document: Koji Tomita, “Re: Adhesive Agent in Use for Display”, Monthly Display, Vol. 15, No. 10, PP. 44-48, in 2009, Techno Times Co., Ltd., or the like.). Under the use condition of an ordinary liquid crystal television, it is conceivable that this shrinkage phenomenon is not a phenomenon which occurs in such a short time period of from several seconds to several minutes, but a phenomenon which makes progress by taking a longer time period.

From the ununiformity phenomenon by the light leakage shown in FIG. 9, it is possible to confirm that the ununiformity occurs mainly at the peripheral portions of the picture screen. As described above, the adhesive agent has a very soft viscoelastic body and is distorted (deformed) when stress is applied, and if the stress is not released before the distortion thereof exceeds the very minute range, the viscous characteristic appears, so that the original shape cannot be restored. The shrinkage of the polarizing plate, which induces the ununiformity phenomenon, corresponds to the shrinkage ratio exceeding the range of the distortion in which the adhesive agent presents an elastic behavior and even if taking a consideration from the time period required for the shrinking thereof, it is clear that the viscous characteristic appeared. In particular, the distortion amount of the adhesive agent at the peripheral portion is large.

For example, in case of a usual diagonal 42-inch liquid crystal television having an aspect ratio 16:9, the length in the longitudinal direction of the picture screen thereof is approximately 930 mm. Supposing that 1% thereof shrinks, approximately 9.3 mm shrinks as a whole. Supposing that the center portion does not move, it becomes a situation in which each of the both end portions is to move as much as approximately 4.7 mm toward the center direction of the picture screen. Therefore, the adhesive agent existing between the glass substrate and the polarizing plate is distorted up to approximately 4.7 mm, and the nearer to the periphery, the larger the distortion is. In these polarizing plates, the light leakage becomes large at the peripheral portion, which becomes a cause that the ununiformity phenomenon becomes such as shown in FIG. 9.

In FIG. 1, there is shown an aspect of the shrinkage of the polarizing plate conceptionally. While the polarizing plate portion shrinks as much as 0.5% to 2.0%, the glass substrate hardly shrinks, so that stress is applied to the adhesive agent. Usually, the shrinkage occurs from the periphery toward the center portion, so that as shown in FIG. 1, the adhesive agent which existed at the end portion of the polarizing plate is distorted largely. Supposing that the position of the glass substrate, at which the end portion of the polarizing plate and the glass substrate face each other through the adhesive agent before the shrinkage is set to be a point A as shown in FIG. 1, there occurs difference as much as the shrinkage between the point A and the end of the polarizing plate in the coordinate of the shrinking direction. When considering similar matters for respective points at which the polarizing plate and the glass substrate face each other, there similarly occur differences in the coordinate of the shrinking direction, and the nearer to the periphery, the larger the difference becomes and conversely, the nearer to the center, the smaller the difference becomes. Assuming that the center point does not move at all, the difference at the center point is zero.

In the aforementioned conventional technologies, there was no consideration about these mechanisms which cause the light leakage and in addition, there was not employed a mechanism which was designed based on the measurement value of the birefringence measured by a proper method, so that it is conceivable that it is not possible to make an improvement of sufficient light leakage even if using those technologies.

Also, the invention described in the Patent Document 1 is based on the basic concept disclosed by the unexamined PCT patent publication No. 96/06370-pamphlet. Here, there is disclosed a non-birefringent optical resin material having a composition in which a matrix composed of a transparent polymeric resin is added with a low molecule substance which shows orientational birefringence having a tendency of canceling the orientational birefringence which aforesaid polymeric resin material possesses, and there is described also the application to the bonding agent for the liquid crystal display.

Main difference of the invention described in the unexamined PCT patent publication No. 96/06370-pamphlet with respect to the invention described in the Patent Document 1 lies in an aspect that the birefringence is expressed by photoelastic coefficient. It should be noted that the English term “stress optical coefficient” which is written literally together with the corresponding Japanese term “photoelastic coefficient” is usually translated as “stress optical coefficient” in English. Generally, it is conceivable that the birefringence Δn and the stress σ are proportional and this phenomenon is called as a stress optical law. Then, the proportional constant thereof is defined as stress optical coefficient C. In other words, the stress optical coefficient C is a coefficient having a relation shown in the following formula (1) (see M. Doi, and S. F. Edwards, “INTERNATIONAL SERIES OF MONOGRAPHS ON PHYSICS 73, The Theory of Polymer Dynamics”, OXFORD SCIENCE PUBLICATIONS, 1986, or the like).

Δn=Cσ (1)

As shown in FIG. 2, in the measurement method of the stress optical coefficient C, generally, while fusing the polymer and fiber-forming it into a fiber shape by a constant stress (=tension), the coefficient C is found by measuring the birefringence and the stress by online (see Takeshi Kikutani, Kazuhito Nakano, Wataru Takarada, and Hiroshi Ito, “On-line Measurement of Orientation Development in the High-Speed Melt Spinning Process”, Polymer Engineering and Science, Vol. 39, No. 12, pp. 2349-2357 (1999), or the like).

In other words, since the polymer in the fused state has a viscoelastic body, it is deformed (becomes distorted) when applying a stress. When applying a stress to a very small amount of sample, there occurs a situation in which the deformation thereof becomes larger along with time and the birefringence changes along with time, so that the measurement thereof is difficult. Therefore, the fusion & fiber-forming or the like is carried out as mentioned above and a polymer is made to flow as much as a certain degree or more, and it is necessary, after it becomes a steady state, to measure the birefringence and the stress and to find the stress optical coefficient.

Also, since the stress optical coefficient is a function of temperature, which changes depending on temperature, it does not make sense if the temperature is not specified. In case of also the abovementioned measurement, it is necessary for the temperature of the fused polymer to be measured by online. The change depending on the temperature is large such that it cannot be ignored and it was reported for an acrylic-based polymer in a fusing state that there occurs a situation in which even the positive and negative sign of the birefringence will change (see R. Wimberger-Friedl, “The Peculiar Rheo-optical Behavior of Bisphenol-A-polycarbonate and Polymethylmethacrylate”, Reologica acta, Vol. 30, No. 4, pp. 329-340 (1991)). In other words, even in case of confirming only the positive and negative sign of the birefringence, the temperature must be presented.

Also, differently from the polymer, a compound having a low molecular mass is generally a solid at a temperature equal to or less than the melting point and becomes a liquid at a temperature from the melting point to the boiling point. It is difficult to think that the measurement method of the stress optical coefficient as mentioned above can be applied to such a substance and there is no report example in the scientific papers or the like either.

When considering these matters comprehensively, even if the substance is confined by the stress optical coefficient which is considered to be unmeasurable substantially, it is essentially difficult to repress the light leakage. Also, in order to suppress the light leakage caused by the birefringence according to the stress optical coefficient, it is necessary to present a specific measurement method (about temperature condition or the like) of the stress optical coefficient and numerical values thereof.

In the Patent Document 2 and the Patent Document 3 described above, the adhesive agent is confined by using photoelastic coefficient.

When stress σ is applied to the substance and birefringence Δn, which occurs when deformed elastically, is measured, as a general definition, the photoelastic coefficient means the proportional constant thereof. Here, if it is assumed that the photoelastic coefficient is CE, the following formula is established.

Δn=CEσ (2)

This is a relation formula having basically a similar form as that of aforesaid formula (1), but there occur many cases in which this relation formula (2) is applied with respect to a solid shaped substance. In other words, this is because there are many cases, in case of solid shaped substances, in which the substance is deformed by being applied with a stress and thereafter, when removing the applied stress, the “elasticity” property for returning to the original shape can be observed under a certain condition.

Generally, the adhesive agent is coated on a film surface to be bonded and this is bonded with a glass substrate or a film by being pressed together, so that a certain degree of softness and fluidity will be required. Basically, there is used a polymer whose glass-transition temperature is lower than the room temperature.

Here, in the Patent Document 2, the photoelastic coefficient is measured by producing an adhesive agent layer having a thickness of 30 microns and by using an ellipsometer M-150 manufactured by JASCO Corporation, but it is very difficult to elastically-deform the polymer having flexibility and fluidity after forming a thin film having thickness of around 30 microns.

It should be noted that there is a possibility for a very limited kind of acryl polymer to be produced in a thin film shape and to be mounted on an apparatus for applying a tensile stress to the film while maintaining the shape thereof, but there is such a drawback that this is limited to the application for a limited kind of adhesive agent.

Also, the agent having such a degree of adhesiveness, which can be used as an adhesive agent, has a viscoelastic body, so that the agent is deformed continuously when applied with stress. Even so, in case of trying to measure the photoelastic coefficient by placing the agent in the measuring apparatus, there is a possibility that the measurement can be accomplished for a certain very limited polymer if a very small stress is applied only for a short time period and the measurement is carried out within a range of very small distortion. However, there is extraordinary difficulty in the measurement operation in this manner, so that it is to be anticipated that also the measurement error becomes large.

In the Patent Document 3, with regard to the measurement method of the photoelastic coefficient, a test piece having 2 cm×4 cm size of thickness 25 μm is produced and by using a photoelastic measuring apparatus (Model Name “Spectroscopic Ellipsometer M-220” manufactured by JASCO Corporation); the photoelastic coefficient of the optical for adhesive sheet is measured under a condition of temperature: 23° C., band width: 1 nm, response: 0.5 sec and wavelength measurement range: 260 to 860 nm; and the absolute value of the photoelastic coefficient for the wavelength 400 nm is found out, in which the measurement temperature, the wavelength and the like are clearly described. Basically, the photoelastic coefficient is measured by a similar method as that of the Patent Document 2, so that the abovementioned difficulty is anticipated.

Therefore, in order to repress the light leakage which is induced by the adhesive agent used in the liquid crystal display and to repress the light leakage itself, the present invention has a problem to provide a new method of evaluating the birefringence of the adhesive agent and further, to provide a designing method and a producing method of the adhesive agent using the evaluation method thereof by earnestly studying the difficulties of the technologies in the past, which have been reported until now. Also, the present invention has a problem to provide an adhesive agent in which it is possible to repress the light leakage actually by using that designing method or producing method. Then, the present invention has a problem to provide a polarizing plate and a liquid crystal display device using that adhesive agent, and to provide producing methods thereof.

### SUMMARY OF THE INVENTION

Objects of the invention are achieved by providing a method of evaluating birefringence of an adhesive agent including: preparing a laminated film by applying an adhesive agent to a support body which includes a polymer film whose inherent birefringence is 1×10⁻³ or less; heat-drawing the laminated film; and measuring retardation of the laminated film after being heat-drawn and the layer-thickness of the adhesive agent.

In some implementations, for the polymer film, the photoelastic coefficient thereof is 1×10⁻¹² Pa⁻¹ or less by the absolute value.

In some implementations, the laminated film is a laminated film formed by sandwiching the adhesive agent between the two sheets of support bodies.

In some implementations, the heat-drawing is carried out under a glass-transition temperature or more of the polymer film.

In some implementations, the heat-drawing is carried out under a condition of 70° C. to 150° C. drawing temperature, 50%/min to 1000%/min drawing speed and draw ratio of 1.1 times to 3 times.

Other objects of the invention are achieved by providing a method of designing an adhesive agent including measuring birefringences of plural kinds of adhesive polymer compositions which include polymers and which are used for samples by for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units and for determining the polymer structure based on the obtained birefringence value for every of the repeating units, and applying the determined polymer to the adhesive agent.

In some implementations, a repeating unit in which the birefringence value indicates a negative value and a repeating unit in which the birefringence value indicates a positive value are combined in the process for determining the combination and the combination ratio of the repeating units and for determining the polymer structure.

Some implementations include adjusting the birefringence value by compounding an addition agent or a curative agent. In some implementations, the addition agent is a compound including at least two pieces of aromatic rings inside the molecule.

In some implementations, in case of applying a polymer, whose gel fraction expressed by

[gel fraction(%)]=[mass of insoluble portion(g)]×100/[mass of adhesive agent(g)]

is 0.1% or more and less than 80%, to the adhesive agent, heat-drawing in the birefringence evaluation method is carried out by drawing temperature of 102° C., by drawing speed of 400%/min and by draw ratio of twice, and the combination and the combination ratio of the repeating units are determined such that the absolute value of the birefringence obtained by adding, in response to the combination ratio, the birefringence value for every of the repeating units, which were obtained at that time, becomes 4×10⁻⁴ or less, whereby the polymer structure is determined.

In some implementations, in case of applying a polymer, whose gel fraction expressed by

[gel fraction(%)]=[mass of insoluble portion(g)]×100/[mass of adhesive agent(g)]

is 80% or more, to the adhesive agent, heat-drawing in the birefringence evaluation method is carried out by drawing temperature of 102° C., by drawing speed of 400%/min and by draw ratio of twice, and the combination and the combination ratio of the repeating units are determined such that the absolute value of the birefringence obtained by adding, in response to the combination ratio, the birefringence value for every of the repeating units, which were obtained at that time, becomes 15×10⁻4 or less, whereby the polymer structure is determined.

Further objects of the invention are achieved by providing a method of producing an adhesive agent including: measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent.

In some implementations, a repeating unit in which the birefringence value indicates a negative value and a repeating unit in which the birefringence value indicates a positive value are combined in the process for determining the combination and the combination ratio of the repeating units.

Some implementations include adjusting the birefringence value by compounding an addition agent or a curative agent.

Still further objects of the invention are achieved by providing an adhesive agent produced by a method including: measuring birefringences of plural kinds of adhesive polymer compositions which include polymers and which are used for samples by for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent.

In some implementations, a repeating unit in which the birefringence value indicates a negative value and a repeating unit in which the birefringence value indicates a positive value are combined in the step of determining the combination and the combination ratio of the repeating units.

Some implementations include adjusting the birefringence value by compounding an addition agent or a curative agent. In some implementations, the addition agent is a compound including at least two pieces of aromatic rings inside the molecule.

In some implementations, in case of applying a polymer, whose gel fraction expressed by

[gel fraction(%)]=[mass of insoluble portion(g)]×100/[mass of adhesive agent(g)]

is 0.1% or more and less than 80%, to the adhesive agent, heat-drawing in the birefringence evaluation method is carried out by drawing temperature of 102° C., by drawing speed of 400%/min and by draw ratio of twice, and the combination and the combination ratio of the repeating units are determined such that the absolute value of the birefringence obtained by adding, in response to the combination ratio, the birefringence value for every of the repeating units, which were obtained at that time, becomes 4×10⁻⁴ or less.

In some implementations, in case of applying a polymer, whose gel fraction expressed by

[gel fraction(%)]=[mass of insoluble portion(g)]×100/[mass of adhesive agent(g)]

is 0.1% or more and less than 80%, to the adhesive agent, the heat-drawing is carried out by drawing temperature of 102° C., by drawing speed of 400%/min and by draw ratio of twice, and the combination and the combination ratio of the repeating units are determined such that the absolute value of the birefringence obtained by adding, in response to the combination ratio, the birefringence value for every of the repeating units, which were obtained at that time, becomes 15×10⁻⁴ or less.

In some implementations, adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent; wherein the absolute value of the birefringence obtained when carrying out the heat-drawing by drawing temperature of 102° C., by drawing speed of 400%/min and by draw ratio of twice is 4×10⁻⁴ or less, and the gel fraction is 0.1% or more and less than 80%.

Other objects of the invention are achieved by providing an adhesive agent produced by a method comprising:

measuring birefringences of plural kinds of adhesive polymer compositions which include polymers and which are used for samples by, for each adhesive polymer composition,

preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;

calculating birefringence corresponding to each repeating unit in said polymers from the values of said birefringences of said polymer compositions,

determining the combination and the combination ratio of the repeating units based on said obtained birefringence value for every of the repeating units,

synthesizing a polymer by polymerizing monomers corresponding to said repeating units by said determined ratio, and

applying said synthesized polymer to the adhesive agent;

wherein a repeating unit in which said birefringence value indicates a negative value and a repeating unit in which said birefringence value indicates a positive value are combined in the step of determining the combination and the combination ratio of said repeating units.

In some implementations, the birefringence value is adjusted by compounding an addition agent or a curative agent.

Other objects of the invention are achieved by providing an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent; wherein the absolute value of the birefringence obtained when carrying out the heat-drawing by drawing temperature of 102° C., by drawing speed of 400%/min and by draw ratio of twice is 15×10⁻⁴ or less, and the gel fraction is 80% or more.

Other objects of the invention are achieved by providing a method of producing a polarizing plate including bonding a polarizing film and a glass substrate together by using an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent;

calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent.

Other objects of the invention are achieved by providing a method of producing a liquid crystal display device including a backlight, a liquid crystal layer, and a polarizing plate having a polarizing film and a glass substrate, including a process for bonding the polarizing film and the glass substrate together by using an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent.

Other objects of the invention are achieved by providing a polarizing plate, including a polarizing film and a glass substrate that are bonded together by an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent; wherein the absolute value of the birefringence obtained when carrying out the heat-drawing by drawing temperature of 102° C., by drawing speed of 400%/min and by draw ratio of twice is 4×10⁻⁴ or less, and the gel fraction is 0.1% or more and less than 80%.

Other objects of the invention are achieved by providing a liquid crystal display device including a backlight, a liquid crystal layer, a polarizing plate having a polarizing film and a glass substrate, wherein the polarizing film and the glass substrate are bonded together by an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent; wherein the absolute value of the birefringence obtained when carrying out the heat-drawing by drawing temperature of 102° C., by drawing speed of 400%/min and by draw ratio of twice is 4×10⁻⁴ or less, and the gel fraction is 0.1% or more and less than 80%.

Other objects of the invention are achieved by providing an adhesive agent, wherein the absolute value of the adhesive's inherent birefringence which is obtained by the method of claim 5 is 4×10⁻⁴ or less.

Other objects of the invention are achieved by providing anadhesive agent, wherein the absolute value of the adhesive's inherent birefringence which is obtained by the method of claim 5 is 2×10⁻⁴ or less.

Other objects of the invention are achieved by providing anadhesive agent, wherein the absolute value of the adhesive's inherent birefringence which is obtained by the method of claim 9 is 4×10⁻⁴ or less.

Other objects of the invention are achieved by providing anadhesive agent, wherein the absolute value of the adhesive's inherent birefringence which is obtained by the method of claim 9 is 2×10⁻⁴ or less.

In some implementations, the polarizing plate includes an adhesive agent, wherein the absolute value of the adhesive's inherent birefringence which is obtained by the method of claim 5 is 4×10⁻⁴ or less.

Other objects of the invention are achieved by providing an adhesive agent obtained by the method of claim 10 in which the gel fraction is 80% or more and the absolute value of the adhesive's inherent birefringence is 15×10⁻⁴ or less.

In some implementations, the gel fraction thereof is 85% or more.

Other objects of the invention are achieved by providing a method of evaluating birefringence of an adhesive agent including: drawing the adhesive agent which lies on a polymer film together with the polymer film and for forming a drawn film; measuring retardation of the drawn film; and

measuring layer-thickness of the adhesive agent, wherein the birefringence is found by dividing the retardation by the thickness.

Other objects of the invention are achieved by providing a method of evaluating birefringence of an adhesive agent including: drawing a sample obtained by sandwiching the adhesive agent between two sheets of polymer films; measuring retardation inside the film surface of the polymer film; and, measuring layer-thickness of the adhesive agent; wherein the birefringence is found by dividing the retardation by the thickness.

Other objects of the invention are achieved by providing a polarizing plate which is bonded together with an adhesive agent produced according to the method of claim 16, including at least one film selected from the group consisting of a polarizing-plate protection film in which the absolute value of the photoelastic coefficient is 8×10⁻¹² Pa⁻¹ or less, or a phase-difference film in which the absolute value of the photoelastic coefficient is 8×10⁻¹² Pa⁻¹ or less.

Other objects of the invention are achieved by providing a method of designing an adhesive agent including: obtaining the birefringence value of an adhesive polymer composition including at least one of an addition agent and a curative agent, and a polymer by preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; and determining the ratio between the polymer and the compound material based on the birefringence value of the polymer composition and for applying it to the adhesive agent.

In some implementations, the addition agent is a compound including at least two pieces of aromatic rings inside the molecule.

Other objects of the invention are achieved by providing a method of producing an adhesive agent including: obtaining the birefringence value of an adhesive polymer composition including at least one of an addition agent and a curative agent, and a polymer by preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of

the adhesive agent; and determining the ratio between the polymer and the compound material based on the birefringence value of the polymer composition and for applying it to the adhesive agent.

In some implementations, the addition agent is a compound including at least two pieces of aromatic rings inside the molecule.

Other objects of the invention are achieved by providing an adhesive agent produced by:

obtaining the birefringence value of an adhesive polymer composition including at least one of an addition agent and a curative agent, and a polymer by preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; and determining the ratio between the polymer and the compound material based on the birefringence value of the polymer composition and for applying it to the adhesive agent.

In some implementations, the addition agent is a compound including at least two pieces of aromatic rings inside the molecule.

In some implementations, the addition agent is a compound including at least two pieces of aromatic rings inside the molecule.

Other objects of the invention are achieved by providing anadhesive agent, wherein the absolute value of the adhesive's inherent birefringence which is obtained by the method of evaluating birefringence according to claim 5 is 15×10⁻⁴ or less and the gel fraction is 80% or more.

Other objects of the invention are achieved by providing a polarizing plate, including a polarizing film and a glass substrate that are bonded together by an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent; wherein the absolute value of the birefringence obtained when carrying out the heat-drawing by drawing temperature of 102° C., by drawing speed of 400%/min and by draw ratio of twice is 15×10⁻⁴ or less, and the gel fraction is 80% or more.

Other objects of the invention are achieved by providing a liquid crystal display device including a backlight, a liquid crystal layer, a polarizing plate having a polarizing film and a glass substrate, wherein the polarizing film and the glass substrate are bonded together an adhesive agent obtained by measuring birefringences of plural kinds of adhesive polymer compositions which include polymers and which are used for samples by, for each adhesive polymer composition, preparing a laminated film by applying the adhesive agent to a support body which includes a polymer film whose inherent birefringence is 1×10⁻³ or less, heat-drawing the laminated film, and measuring retardation of the laminated film after being heat-drawn and the layer-thickness of the adhesive agent; calculating birefringence corresponding to each repeating unit in the polymers from the values of the birefringences of the polymer compositions, determining the combination and the combination ratio of the repeating units based on the obtained birefringence value for every of the repeating units, synthesizing a polymer by polymerizing monomers corresponding to the repeating units by the determined ratio, and applying the synthesized polymer to the adhesive agent; wherein the absolute value of the birefringence obtained when carrying out the heat-drawing by drawing temperature of 102° C., by drawing speed of 400%/min and by draw ratio of twice is 15×10⁻⁴ or less, and the gel fraction is 80% or more.

Various kinds of inventions are also conceivable other than the abovementioned inventions.

It is allowed to employ a method of designing a low-birefringent adhesive agent as one of other inventions, wherein in case of applying a polymer, whose gel fraction expressed by *Formula (3) shown below is 28% or more and less than 55%, to the adhesive agent, heat-drawing in aforesaid birefringence evaluation method is carried out by drawing temperature of 102° C., by drawing speed of 400%/min and by draw ratio of twice, and the combination and the combination ratio of aforesaid repeating units are determined such that the absolute value of the birefringence obtained by adding, in response to the combination ratio, the birefringence value for every of aforesaid repeating units, which were obtained at that time, becomes 3×10⁻⁴ or less, whereby the polymer structure is determined.

*[gel fraction(%)]=[mass of insoluble portion(g)]×100/[mass of adhesive agent(g)] Formula (3)

It is allowed to employ a method of designing a low-birefringent adhesive agent as one of other inventions, wherein in case of applying a polymer, whose gel fraction expressed by *Formula (3) shown below is 55% or more and less than 80%, to the adhesive agent, heat-drawing in aforesaid birefringence evaluation method is carried out by drawing temperature of 102° C., by drawing speed of 400%/min and by draw ratio of twice, and the combination and the combination ratio of aforesaid repeating units are determined such that the absolute value of the birefringence obtained by adding, in response to the combination ratio, the birefringence value for every of aforesaid repeating units, which were obtained at that time, becomes 4×10⁻⁴ or less, whereby the polymer structure is determined.

It is allowed to employ a method of producing a low-birefringent adhesive agent as one of other inventions, wherein in case of applying a polymer, whose gel fraction expressed by *Formula (3) shown below is 28% or more and less than 55%, to the adhesive agent, heat-drawing in aforesaid birefringence evaluation method is carried out by drawing temperature of 102° C., by drawing speed of 400%/min and by draw ratio of twice, and the combination and the combination ratio of aforesaid repeating units are determined such that the absolute value of the birefringence obtained by adding, in response to the combination ratio, the birefringence value for every of aforesaid repeating units, which were obtained at that time, becomes 3×10⁻⁴ or less.

*[gel fraction(%)]=[mass of insoluble portion(g)]×100/[mass of adhesive agent(g)] Formula (3)

It is allowed to employ a method of producing a low-birefringent adhesive agent as one of other inventions, wherein in case of applying a polymer, whose gel fraction expressed by aforesaid *Formula (3) is 55% or more and less than 80%, to the adhesive agent, heat-drawing in aforesaid birefringence evaluation method is carried out by drawing temperature of 102° C., by drawing speed of 400%/min and by draw ratio of twice, and the combination and the combination ratio of aforesaid repeating units are determined such that the absolute value of the birefringence obtained by adding, in response to the combination ratio, the birefringence value for every of aforesaid repeating units, which were obtained at that time, becomes 4×10⁻⁴ or less.

It is allowed to employ an adhesive agent obtained by the method of producing a low-birefringent adhesive agent as one of other inventions, wherein the absolute value of the birefringence obtained when carrying out the heat-drawing in the method of evaluating birefringence by drawing temperature of 102° C., by drawing speed of 400%/min and by draw ratio of twice is 3×10⁻⁴ or less, and the gel fraction is 28% or more and less than 55%.

It is allowed to employ an adhesive agent obtained by the method of producing a low-birefringent adhesive agent as one of other inventions, wherein the absolute value of the birefringence obtained when carrying out the heat-drawing in the method of evaluating birefringence according to any one of claims 1 to 3 by drawing temperature of 102° C., by drawing speed of 400%/min and by draw ratio of twice is 4×10⁻⁴ or less, and the gel fraction is 55% or more and less than 80%.

It should be noted that in the adhesive agents, there is included, for example, a bonding agent which is an agent for carrying our the bonding by pressure and whose configuration does not change before and after the bonding or a bonding agent which is liquid before carrying our the bonding, which is crosslinked after the bonding by applying heat or ultraviolet, and in which the glass-transition temperature after the crosslink is 0° C. or less.

Also, in the present specification, the term referred to as “addition agent” will be used as a synonym of the term referred to as “compound agent”.

The term “plasticizer” is a lower concept of the term “addition agent”. Specifically, as an example of the “addition agent”, there can be cited a “compound having at least two pieces of aromatic rings inside the molecule” and as an example of the “compound having at least two pieces of aromatic rings inside the molecule”, there can be cited “a certain plasticizer”.

It is possible for an example of the “compound having at least two pieces of aromatic rings inside the molecule” to cite “benzylbenzoate”. Also, as an example of the “compound having at least two pieces of aromatic rings inside the molecule”, there exists “trans-stilbene (stilbene)”.

A compound showing the opposite birefringence is included in an addition agent. Specifically, benzylbenzoate or trans-stilbene showing positive birefringence is compounded to the polymer showing negative birefringence. The “compound having at least two pieces of aromatic rings inside the molecule” shows positive birefringence and plays the role of adjusting the birefringence by being compounded with the polymer having negative birefringence.

### Effect of the Invention

According to the present invention, there is provided a novel method of evaluating birefringence of an adhesive agent, which is excellent in workability and in accuracy of the measurement. Further, there are provided a designing method of an adhesive agent and a producing method of an adhesive agent, which use that evaluation method. Also, there are provided an adhesive agent, a polarizing plate, a liquid crystal display device, a method of producing a polarizing plate, and a method of producing a liquid crystal display device, in which it is possible to repress the “light leakage” actually by using that designing method or that producing method.

Still other purposes, characteristic or advantages of the present invention will become clear in accordance with the detailed explanations based on exemplified embodiments of the present invention mentioned later and the attached drawings.

### BRIEF DESCRIPTION OF DRAWINGS

FIG. 1 is a diagram showing an aspect of shrinkage of a polarizing plate conceptionally;

FIG. 2 is a diagram for explaining an ordinary apparatus of measuring a stress optical coefficient;

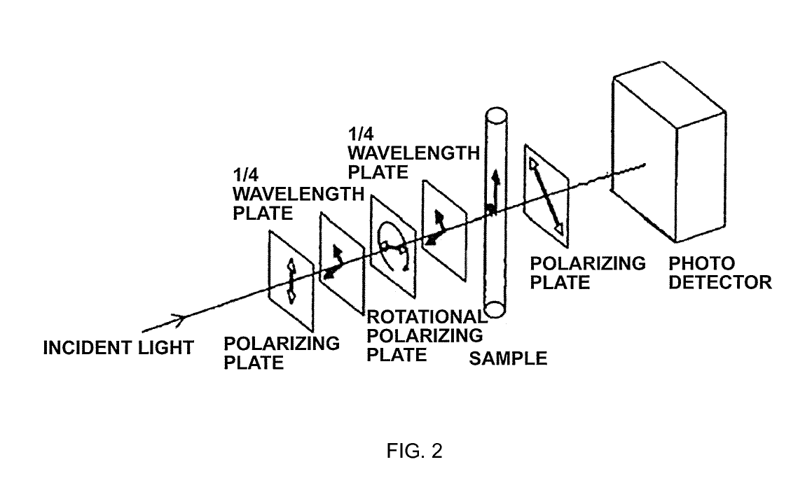

FIG. 3 is a diagram for explaining a shape of a measurement sample which is used for a method of evaluating birefringence in the present invention;

FIG. 4 is a graph for explaining draw-ratio dependence of the birefringence value of a phenoxyethylacrylate polymer, which is measured by a method of evaluating birefringence of an adhesive agent in the present invention;

FIG. 5 is a graph showing a measurement result of the birefringence of a polymer which is synthesized by changing the ratio of butylacrylate/phenoxyethylacrylate;

FIG. 6 is a diagram for explaining a measurement sample for evaluating the light leakage by using a butylacrylate/phenoxyethylacrylate copolymer as an adhesive agent;

FIG. 7 shows photographs imaging aspects of the light leakages when using a butylacrylate/phenoxyethylacrylate copolymer as an adhesive agent;

FIG. 8 is a diagram for explaining a layer constitution of an ordinary liquid crystal panel;

FIG. 9 is a diagram for explaining occurrence of a ununiformity phenomenon caused by shrinkage of a polarizing plate;

FIG. 10 is a diagram showing a relation between AAc concentration and adhesive's inherent birefringence in case of an inventive example 7;

FIG. 11 is a diagram showing a relation between a plasticizer (benzylbenzoate) and adhesive's inherent birefringence in case of an inventive example 8;

FIG. 12 is a diagram showing a relation between trans-stilbene and adhesive's inherent birefringence in case of an inventive example 9;

FIG. 13 is a diagram showing a relation between amount of curative agent and adhesive's inherent birefringence in case of an inventive example 10;

FIG. 14 is a diagram showing a relation between adhesive's inherent birefringence and distortion of polarization state at the time of deformation;

FIG. 15 is a diagram showing an evaluation example of the distortion of polarization state;

FIG. 16 is a diagram showing a relation between gel fraction (gel fraction %) and shrinkage ratio in case of an inventive example 3 or the like; and

FIG. 17 is a diagram showing a relation between gel fraction and adhesive's inherent birefringence in case of an inventive example 12.

### DETAILED DESCRIPTION OF THE INVENTION

### Evaluation Method of Birefringence of Adhesive Agent

The birefringence evaluation method of the present invention is characterized in that there is used, for a support body, a film formed by a polymer in which birefringence almost does not occur regardless of the existence or nonexistence of the drawing thereof. The polymer in which birefringence almost does not occur regardless of the existence or nonexistence of the drawing thereof (hereinafter, referred to as “zero-zero birefringence polymer” in the present specification) is described, for example, in a literature of Akihiro Tagaya, Hisanori Ohkita, Tomoaki Harada, Kayoko Ishibashi, and Yasuhiro Koike, “Zero-Birefringence Optical Polymers”, Macromolecules, 39, pp. 3019-3023 (2006) or the like.

It should be noted in the present invention that the “film formed by a polymer in which birefringence almost does not occur” means a film whose inherent birefringence is 1×10⁻³ or less by the absolute value and whose photoelastic coefficient is 1×10⁻¹² Pa⁻¹ or less by the absolute value.

Within the plurality of zero-zero-birefringence polymers described in the aforesaid literary document, for example, polymethylmethacrylate (MMA)/2,2,2-trifluoroethylmethacrylate (3FMA)/benzylmethacrylate=52.0/42.0/6.0 (mass ratio) has approximately 0 inherent birefringence, in which the orientational birefringence thereof almost does not occur even if thermally drawn, the photoelastic coefficient thereof is around 0.119×10⁻¹² Pa⁻¹, and the birefringence thereof almost does not appear even if applying a stress under a condition of a temperature equal to or less than the glass-transition temperature. This is a size which can be regarded as approximately zero in an ordinary birefringence measuring apparatus. Also, the glass-transition temperature is approximately 90° C.

There is no severe restriction with regard to the glass-transition temperature of the zero-zero-birefringence polymers, but in consideration of a situation in which the heat-drawing is carried out at around 100° C. as an acceleration test for confirming a shrinkage phenomenon fitting in with the use condition of an actual polarizing plate and a situation in which the measurement is made to be easy by maintaining the shape after cooling the temperature up to the room temperature, it is preferable to employ a temperature higher than the room temperature and lower than 100° C. which is the heating temperature in the acceleration test, and it is preferable to employ a temperature around approximately 90° C.

With regard to the sample for evaluation of birefringence, first, a film formed by zero-zero-birefringence polymers is produced as many as one sheet or two sheets according to a publicly-known film production method. It is preferable for the thickness thereof to be around 20 μm to 100 μm. Making this film as a support body, an adhesive agent is applied to this support body. It is allowed to use this laminated layer body applied with the adhesive agent on the support body as a sample for evaluation, but it is preferable, by using the zero-zero-birefringence polymer film as many as two sheets, to use the laminated layer body applied with the adhesive agent of the measurement target between these two sheets as a sample for evaluation. In case of using the zero-zero-birefringence polymer film as many as two sheets, another one sheet of the zero-zero-birefringence polymer film is bonded-together with the aforesaid adhesive agent coated on the support body.

By applying the adhesive agent between the two sheets of zero-zero-birefringence polymer films, there can be realized a situation close to the situation which can occur actually in the liquid crystal display device and in which there occurred a shear stress of the adhesive agent toward the in-plain direction, and it can be guessed that an evaluation closer to that of the actual state becomes possible. Also, the laminated layer body applied with the adhesive agent on the in-plain thereof is excellent in operability.

It is preferable for the layer-thickness of the adhesive agent in the produced sample for evaluation to be 20 μm to 50 μm and it is more preferable to bring the thickness closer to the layer-thickness of the adhesive agent when being finally used practically for the liquid crystal display or the like.

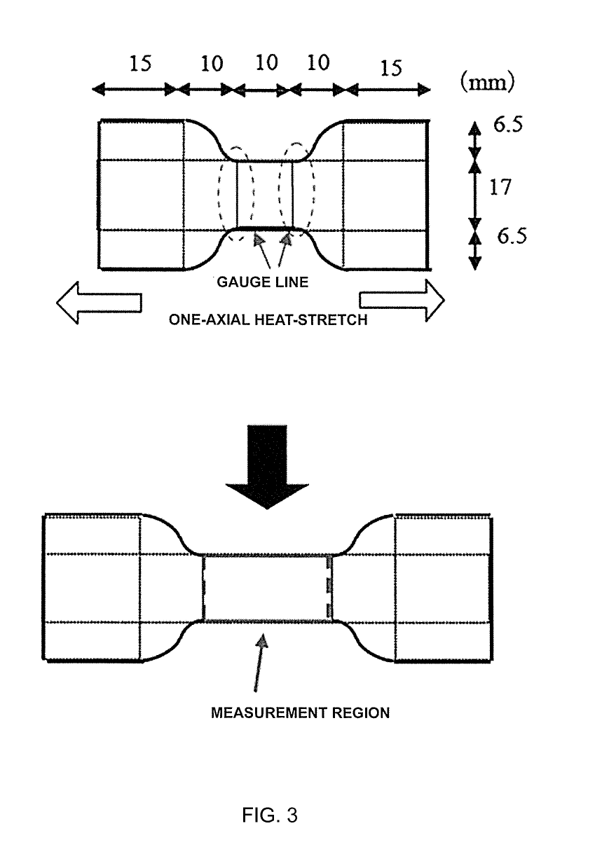

Next, the sample is processed into a shape matching the drawing apparatus (drawing test machine) in order to be heat-drawn. In general, similarly as the evaluation sample of a tension testing machine or the like, it is desirable to process a sample for evaluation into a dumbbell shape as shown in FIG. 3. For the shape & size of the dumbbell, a variety of kinds are usable if they are the kinds which can be applied with a necking process at the time of the one axial heat-drawing and in which the drawn portion can be drawn approximately uniformly. The sample for evaluation processed into a dumbbell shape is heated to the glass-transition temperature or more (in the vicinity 100° C.) of the zero-zero-birefringence polymer film and is one-axially drawn.

After the draw, the drawn film is taken out from the apparatus immediately and is cooled by leaving it under the room temperature. After leaving the film for approximately 24 hours under the room temperature, retardation (=[birefringence]×[thickness]) inside the film surface is measured. The retardation is measured by a commercially available birefringence measuring apparatus. After the retardation measurement, the cross-section of the measured portion of the sample for evaluation is observed by a microscope or the like and the layer-thickness of the adhesive agent is measured. The retardation measured previously is divided by the thickness whereby the birefringence is found.

In this method, the measurement is carried out by supporting the adhesive agent which is a measurement target by the film composed of a zero-zero birefringence polymer, so that it is possible to carry out the measurement of the adhesive agent simply and also appropriately, in which the handling of the agent was difficult due to the adhesiveness and the flexibility thereof. Further, the support is carried out by the film composed of a zero-zero birefringence polymer, so that the birefringence by the film which was used as a support body of the measurement sample does not exert influence on the birefringence value which was obtained by the measurement.

Also, in the measurement method of the present invention, the adhesive agent is supported by the film composed of a zero-zero birefringence polymer and the birefringence is measured after this agent is heat-drawn, so that the method is suitable as a birefringence evaluation method of an adhesive agent for repressing the “light leakage”. There will be described the reason thereof hereinafter.

Shrinkage of a polarizing plate, which induces the “light leakage”, is caused by a phenomenon in which the film including iodine and having polyvinylalcohol as a main component shrinks by heat. It was reported that this shrinkage occurs also at a temperature around 60° C. under a high humidity (see Patent Document: Koji Tomita, “RE: Adhesive Agent for Use Application of Display”, Monthly Display, Vol. 15, No. 10, pp. 44 to 48, in 2009, Techno Times Co., Ltd., or the like). Therefore, it is usual for the acceleration test of this shrinkage phenomenon depending on the temperature to be carried out at around 100° C. Consequently, for such a test method in which the heat-drawing is carried out under a temperature of around 100° C. by using the aforementioned zero-zero-birefringence polymers, there is employed a configuration in which approximately the same condition is applied as that of the acceleration test which confirms the shrinkage phenomenon fitting-in with the use condition.

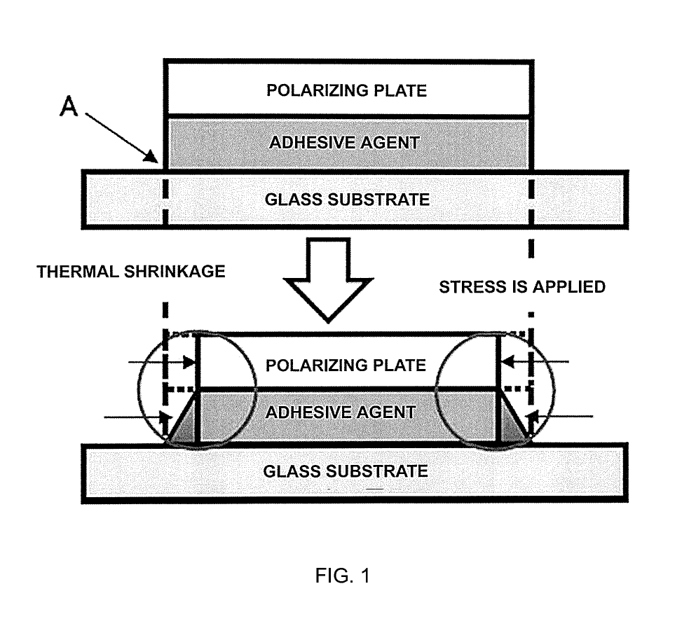

Also, at the time of the shrinkage, as shown in FIG. 1, such a shear stress which moves the surface layer of the adhesive agent toward the bonded in-plain direction will act toward the shrinking direction of the polarizing plate. In the method of heat-drawing the adhesive agent by sandwiching the zero-zero-birefringence polymer films, similarly, a shear stress acts on the adhesive agent layer toward the in-plain direction by the phenomenon that the polymer film is heated and expanded. In this manner, the fact that the shear stress can be applied to the adhesive agent in the same direction as the actual state is important for evaluating the birefringence of the adhesive agent, which becomes a cause of the “light leakage”.

The measurement of the birefringence is carried out by measuring the in-plain birefringence of the adhesive agent, which occurs by the shear stress. It is possible for the measurement to use a variety of optical methods, in which the matter in common among them lies in an aspect that the light enters & penetrates the film surface approximately perpendicularly and the birefringence is found by measuring the retardation which occurs when the light passes through the film. In an actual liquid crystal display, the shrinking direction of the polarizing plate is the in-plain direction and the light from the backlight passes through the polarizing plate. Therefore, the direction of the shear stress toward which the birefringence is induced and the measurement direction of the birefringence (light passing-through direction) have an orthogonal relation with each other.

It should be noted that the direction of the shear stress by the heat-drawing is the same direction as the shrinking direction which induces the birefringence in the actual liquid crystal display and also, there is employed a configuration in which the measurement direction of the birefringence is the same direction as the light passing-through direction in the actual liquid crystal display. The cause of the birefringence lies in the orientation of the polymer molecules and the orientation thereof has a close relation with the stress direction. In other words, the direction toward which the stress is applied in the birefringence measurement and the direction passing-through the light have an important relation and it is conceivable also in this aspect that this method is suitable for evaluating the birefringence of the adhesive agent, which becomes a cause of the “light leakage” in the actual liquid crystal display.

The glass-transition temperature of the zero-zero-birefringence polymer film is sufficiently higher than the room temperature, so that it becomes a state in which the zero-zero-birefringence polymer film sandwiches the adhesive agent layer while maintaining the shape thereof after the film is heat-drawn and is cooled up to the room temperature. Even in an actual liquid crystal display, after the polarizing plate shrinks up to around the shrinkage ratio which can be usually observed, the shape thereof is maintained approximately in that state and it becomes a state in which the adhesive agent is sandwiched between the polarizing plate and the glass substrate or the like.

The measurement value by the evaluation method of the birefringence of the present invention depends on the content ratio of the crosslink structure. Therefore, in order to obtain the sign & the relative magnitude relationship of the birefringence quantitatively with regard to the main component (the kind of polymer) constituting the adhesive agent, it is necessary to use the measurement value under a condition in which the content ratio of the crosslink structure is approximately identical.

It is possible for the content ratio of the crosslink structure to be evaluated by gel fraction in an easy case. The gel fraction is measured by the following procedure. First, the adhesive agent is soaked in a solvent and by using a metal filter having 200 meshes, that object is separated into an insoluble portion (residual portion on the filter) and a soluble portion. Toluene is applied as the solvent thereof. The insoluble portion is dried, measured for the weight thereof and thereafter, the ratio with respect to the mass of the adhesive agent of the insoluble portion is found and this is made to be “gel fraction”. Specifically the “gel fraction” is found by the following formula (3).

[gel fraction(%)]=[mass of insoluble portion(g)]×100/[mass of adhesive agent(g)] (3)

Also, the measurement value by the birefringence evaluation method of the present invention depends also on the drawing condition.

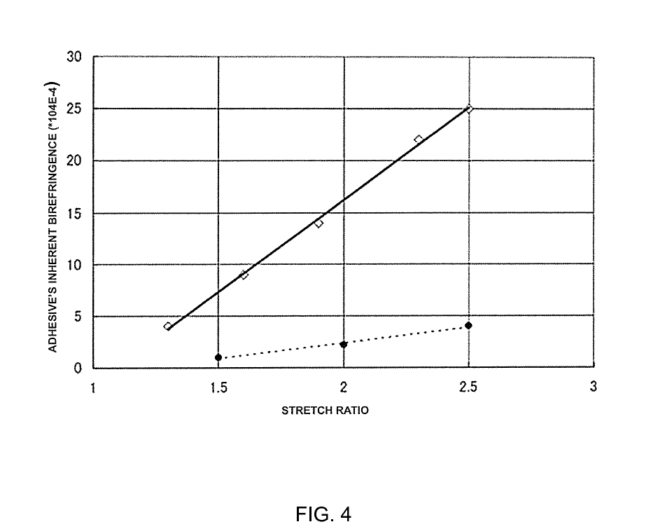

An example of the draw ratio dependence of the birefringence value measured by a method of evaluating birefringence of an adhesive agent in the present invention is shown in FIG. 4. FIG. 4 shows a result in which a curative agent A is added to phenoxyethylacrylate (PHEA) as much as a reference amount and in which the synthesized adhesive agent is sandwiched by the zero-zero-birefringence polymer film and is one-axially heat-drawn after being processed into a dumbbell shape as shown in FIG. 3. The compound prescription of the curative agent A is carried out by 1 pts. of Coronate L (manufactured by Nippon Polyurethane Industry Co., Ltd), 0.5 pts. of Alumichelate A (manufactured by Kawaken Fine Chemicals Co., Ltd.), and 0.1 pts. of KBM-803 (manufactured by Shinetsu Chemical Industry Co., Ltd.). For the drawing thereof, there was used a tensilon universal tester (manufactured by A&D Co., Ltd.). The drawing temperature is 102° C. and the drawing speed is 40 mm/min. The length of the drawn portion is 10 mm and is 400%/min. The draw ratio is defined by the value dividing the interval of the gauge lines after the drawing by the interval of the gauge lines before the drawing.

From FIG. 4, it is understood that the birefringence measured by the evaluation method of the present invention and the draw ratio have a linear relation. This means that the polymer molecules are oriented along with the increase of the draw ratio. Therefore, if the draw ratio is set so as to become a certain value, it is conceivable that the degrees of orientation of various kinds of adhesive agents among a variety of polymer components come to have certain correlative relations mutually. These relations depend also on the drawing temperature and the drawing speed, so that it is necessary to set the drawing temperature and the drawing speed to be in predetermined conditions similarly as the draw ratio. More specifically, if the draw ratio, the drawing temperature and the drawing speed lie within predetermined ranges, these factors and the degree of orientation of the polymer component are correlated, so that it is possible to measure the birefringence.

Generally, it is desirable for the drawing temperature to be 70° C. to 150° C., and more desirably to be 80° C. to 130° C.; it is desirable for the drawing speed to be 50%/min to 1000%/min, and more desirably to be 100%/min to 600%/min; and it is desirable for the draw ratio to be 1.1 times to 3 times, and more desirably to be 1.5 times to 2.5 times.

It should be noted that in order to obtain the sign & the relative magnitude relationship of the birefringence quantitatively with regard to the main component (the kind of polymer) which constitutes the adhesive agent, it is necessary to use the measurement value obtained under a drawing condition of approximately the same condition.

### <Designing Method of Adhesive Agent>

When coating the adhesive agent which shows sufficiently small birefringence in the method of evaluating birefringence of the aforementioned adhesive agent actually onto a polarizing plate and carrying out an acceleration test of the shrinkage of the polarizing plate, it was confirmed that there was obtained a sufficient repressing effect of the “light leakage”.

Based on the aforementioned evaluation method, it is possible to analyze the (positive and negative) sign & the relative magnitude relationship of the birefringence with regard to the main component (the kind of polymer) constituting the adhesive agent.

The most clear-cut method is a method in which there is added a test reagent (to be referred to as a curative agent in the present specification) for forming a crosslink structure for one type inside the monomers which become a raw material of the adhesive agent and there is evaluated the birefringence of the polymer which is close to a homo polymer comparatively and which is obtained by being polymerized.

By carrying out this evaluation with regard to various kinds of monomers to be used for the adhesive agents, it is possible to obtain the sign & the relative magnitude relationship of the birefringence quantitatively. It is also possible to rephrase the birefringence inherent to the polymer as “birefringence of the repeating unit structure of that polymer” and it is possible from the birefringences of those polymers to approximately presume the birefringence of the copolymer constituted by those polymers (see Akihiro Tagaya, Hisanori Ohkita, Tomoaki Harada, Kayoko Ishibashi, and Yasuhiro Koike, “Zero-Birefringence Optical Polymers”, Macromolecules, 39, pp. 3019-3023 (2006), or the like). That is because it is generally possible to obtain the birefringence of the copolymer if adding the birefringence of each component (repeating unit) in response to the composition ratio.

Therefore, if using the knowledge with regard to the respective components obtained by the method of evaluating the birefringence according to the present invention, it is possible by a simple calculation to find such a composition in which the absolute value of the birefringence becomes a desired value or less.

It should be noted that it is not always necessary to use a homopolymer in the aforementioned method of evaluating the birefringence in order to find the birefringence of each component if there is considered the fact that an additive property is true between the birefringence and the composition. If it is possible by the measurement to clarify the relation between the composition ratio of the copolymer and the birefringence, it is possible based on that fact to find the birefringence of each component.

Also, it is allowed for the sample used for estimating the “birefringence of the repeating unit structure of the polymer” to utilize, other than the homopolymer and the copolymer, a polymer composition including a low-molecular-weight compound or the like such as a curative agent, a monomer, a stilbene and the like. It should be noted that in order to obtain the sign & the relative magnitude relationship of the birefringence of the repeating unit structure quantitatively by using the polymer composition, it is desirable, in order to suppress the influence of the birefringence by the curative agent or the low-molecular-weight compound, to use a polymer composition in which the content ratio of the curative agent and the low-molecular-weight compound is arranged.

More specifically, in order to design an adhesive agent having a low birefringence by using the method of evaluating the birefringence according to the present invention, first, by the abovementioned method of evaluating the birefringence, there are measured the birefringences of plural kinds of adhesive polymer compositions (for these polymer compositions, it is allowed to include curative agents or low-molecular-weight compounds and alternatively, it is allowed to employ compositions constituted substantially only by homopolymers or copolymers), which include polymers (either ones of homopolymers and copolymers are available) which are main components constituting the adhesive agent.

At that time, the birefringence value changes depending on the condition of the heat-drawing, so that it is desirable to set the condition of the heat-drawing to be constant in order to obtain the sign & the relative magnitude relationship of the birefringence quantitatively. Also, the birefringence value varies also depending on the crosslink density, so that it is desirable to carry out the measurement by setting the gel fraction, which expresses the crosslink density relatively, to be constant. Further, in case of measuring the birefringence by using the polymer composition, in order to suppress the influence of the birefringence by the curative agent or the low-molecular-weight compound which is included in the polymer composition, it is desirable to use a polymer composition in which the content ratio of the curative agent and the low-molecular-weight compound is arranged.

From the birefringence values of the aforesaid polymer compositions, which are obtained in this manner, there is calculated the birefringence (sign and relative birefringence value of the birefringence) corresponding to each repeating unit.

Then, based on the value of the birefringence (sign and relative birefringence value of the birefringence) obtained for every repeating unit, the combination and the combination ratio of the repeating units are determined such that the birefringence of the aimed polymer becomes a desired value, whereby the aimed polymer structure will be determined. With regard to the adhesive agent applied with this polymer, it is possible to guess the birefringence thereof.

It should be noted that the polymer is designed such that the absolute value of the birefringence of the aimed polymer when adding the birefringence value of the repeating unit in response to the combination ratio thereof becomes close to zero and by using this polymer for the adhesive agent, it is possible to effectively repress the light leakage of the picture screen in the liquid crystal display using the aforesaid adhesive agent. Consequently, when determining the combination and the combination ratio of the aforesaid repeating units, it is desirable to combine a repeating unit in which the birefringence value indicates a positive value and a repeating unit in which the birefringence value indicates a negative value.

In this manner, the nearer the calculated absolute value of the birefringence of the aimed polymer is zero, the more desirable it is, but the range of the absolute value of the birefringence, which is allowable when being applied to the adhesive agent, changes depending on the content ratio (gel fraction) of the crosslink structure. Hereinafter, the details thereof will be explained.

Among the adhesive agents in the past, there is an agent referred to as a “stress relaxation type” in which the crosslink density (content ratio of the crosslink structure) is small and the fluidity is high (see Patent Document: Koji Tomita, “RE: Adhesive Agent for Use-Application of Display”, Monthly Display, Vol. 15, No. 10, pp. 44-48, in 2009, Techno Times Co., Ltd., or the like).

In an adhesive agent of such a type, the orientation of the polymer molecules constituting the adhesive agent is relaxed when time elapses to a certain degree even after the shrinkage of the polarizing plate, and there is a case in which the birefringence becomes very small and the “light leakage” is not to be observed so much. In case of using such an adhesive agent, the birefringence decreases along with time after the drawing even in the aforementioned method of evaluating the birefringence and it is conceivable that the “light leakage” is hardly to be observed after time elapses to a certain degree.

On the other hand, for the adhesive agent in which the crosslink density is high and the fluidity is low, the shrinkage of the adhesive agent does not occur considerably even if the polarizing plate shrinks, and the shape thereof is maintained. Therefore, this agent has such a property that it is difficult for the birefringence to occur.

However, the adhesive agent of the “stress relaxation type” has a lot of problems in the matters such as durability, easy-handling and the like in which the adhesive force becomes low for the adhesive agent having a high crosslink density, so that for the practical use, there is requested an adhesive agent including a crosslink structure by a certain ratio. When using such an adhesive agent including a crosslink structure by a certain ratio, it becomes a situation in which the “light leakage” occurs easily also for an actual liquid crystal display after the shrinkage of the polarizing plate. This shows that there remains the orientation of the polymer molecules, which becomes the source of the birefringence.

Consequently, in the design of the adhesive agent until now, the design was carried out in consideration of the crosslink density and the fluidity caused thereby almost without a consideration with regard to the birefringence and there was adopted a measure of whether to employ an agent having a small crosslink density and a high fluidity or whether to employ an agent having a high crosslink density and a low fluidity, in which it was difficult to design an adhesive agent excellent in durability, operability and/or adhesiveness.

However, in the evaluation method of the present invention, the birefringence is evaluated in a state in which the polymer molecules of the adhesive agent are oriented at the room temperature after being one-axially heat-drawn, so that in the actual liquid crystal display, it is conceivable that the orientation is maintained in a similar state of the orientation of the polymer molecules, which becomes a cause of inducing the “light leakage” and it is possible to evaluate the birefringence directly in that state.

Therefore, if using the evaluation method of the present invention, it is possible to obtain an adhesive agent in which the birefringence is designed to have a proper value in conformity with the crosslink density of the adhesive agent and the application to the polarizing plate or the like is made possible even if there is employed an adhesive agent having a crosslink density, whose full use was difficult until now.

In this manner, since the permissible range of the birefringence is different depending on the content ratio (gel fraction %) of the crosslink structure, the setting range of the birefringence is different.

Specifically, a preferable range of the absolute value of the birefringence is set by dividing the cases into a case (i) in which the gel fraction expressed by the aforementioned formula (3) is 0.1% or more and less than 80% and a case (ii) in which the gel fraction is 80% or more.

It should be noted that in case of arguing the absolute value of the birefringence, it is necessary to consider, as mentioned above, that the birefringence value changes depending on the condition of the heat-drawing. Consequently, in the aforesaid evaluation method, the condition of the heat-drawing is set by the drawing temperature of 102° C., the drawing speed of 400%/min and the draw ratio of twice, in which by using the birefringence value for every repeating unit, which was obtained at that time, the absolute value of the birefringence which will be described hereinafter is made to be the absolute value obtained by adding the birefringence values of these repeating units in response to the combination ratio.

In a case in which the gel fraction is 0.1% or more and less than 80% of the aforesaid case (i), it is preferable for the absolute value of the birefringence of the aimed polymer, which is calculated under the condition of the aforementioned heat-drawing, to be 4×10⁻⁴ or less, and it is more preferable to be 2×10⁻⁴ or less.

In a case in which the gel fraction is 80% or more of the aforesaid case (ii), it is preferable for the absolute value of the birefringence of the aimed polymer, which is calculated under the condition of the aforementioned heat-drawing, to be 15×10⁻⁴ or less, it is more preferable to be 10×10⁻⁴ or less, and it is still more preferable to be 8×10⁻⁴ or less.

Also, the upper limit value of the absolute value of the birefringence, which is effective for repressing the “light leakage”, depends on the layer-thickness of the adhesive agent when being actually used for the liquid crystal display. Consequently, in case of designing an adhesive agent having a low birefringent by using the method of evaluating the birefringence according to the present invention, it is desirable to evaluate the birefringence in conformity with the thickness of the adhesive agent when being used actually in the aforementioned evaluation method.

As mentioned above, it is possible for the method of evaluating the birefringence according to the present invention to measure the birefringence simply and also accurately, and the measurement is carried out in a state close to that of the actual use configuration of the adhesive agent, so that the value can be obtained as a birefringence value fitting-in with the actual state. Consequently, by designing the polymer such that the absolute value of the birefringence becomes within the aforementioned range based on the birefringence value obtained by the aforementioned evaluation method, it is possible, in the liquid crystal display using the adhesive agent applied with this polymer, to repress the light leakage of the picture screen effectively.

Also, even if there is employed an adhesive agent of the gel fraction, whose full use was difficult until now for the reason that it is easy for the birefringence to appear greatly, with regard to the adhesive agent designed by using the method of evaluating the birefringence according to the present invention, the light leakage of the picture screen in the liquid crystal display is repressed even if being used for the polarizing plate or the like. With regard to the adhesive agent having the crosslink density within a specific region, the light leakage is repressed and moreover, simultaneous pursuit of the adhesive force, the durability and the operability is achieved. From the viewpoint of achieving the simultaneous pursuit of these effects, it is preferable for the gel fraction of the adhesive agent to lie in a range of 28% to 80%.

### <Low-Birefringent Adhesive Agent and Producing Method Thereof>

If the polymer used for the low-birefringent adhesive agent of the present invention is designed by such a composition in which the absolute value of the birefringence becomes a desired value or less based on the birefringence value obtained by the aforementioned measurement method, there is no limitation with regard to the material-property thereof. Hereinafter, there will be described one example of a polymer which can be used for the low-birefringent adhesive agent of the present invention.

For the polymer which can be used for the adhesive agent, there can be cited an acrylic-based polymer, an urethane-based polymer, a styrene-based elastomer such as a styrene-isoprene (SIS)-based elastomer, a polyester-based polymer, an olefin-based polymer, and the like.

For the aforesaid acrylic-based polymer, there can be cited a copolymer between at least one kind, which is selected from an alkylester monomer a of carbon numbers 1 to 18 of (meth) acrylic acid and a copolymerizable monomer b having an aromatic ring, and a copolymerizable monomer c having at least one group out of a carboxyl group and a hydroxyl group.

In case of the aforementioned acrylic-based polymer, the birefringence for every repeating unit derived from the monomer a, the monomer b and the monomer c mentioned above is found out by the aforementioned method, and the structure of the acrylic-based polymer used for a desired low-birefringent adhesive agent is to be determined.

For the aforesaid urethane-based polymer, there can be cited a compound obtained by reacting diol and diisocyanate.

For the aforementioned urethane-based polymer, the birefringence for every repeating unit derived from the diol and the diisocyanate mentioned above is found out by the aforementioned method, and the structure of the urethane-based polymer used for a desired low-birefringent adhesive agent is to be determined.

For the aforesaid styrene-based elastomer, there can be cited an SIS (styrene-isoprene-styrene) block copolymer, an SBS (styrene-butadiene-styrene) block copolymer, an ESBS (epoxydized styrene butadiene-styrene) copolymer, and the like.

For the aforementioned elastomer, the birefringence for every repeating unit derived from the aforesaid monomers (for example, styrene, isoprene, butadiene and the like) is found out by the aforementioned method, and the structure of the elastomer used for a desired low-birefringent adhesive agent is to be determined.

Hereinafter, there will be explained the acrylic-based polymer more in detail.

For the aforesaid alkylester monomer a of carbon numbers 1 to 18 of (meth) acrylic acid, there can be cited, for example, methyl (meth)acrylate; ethyl (meth)acrylate; propyl (meth) acrylate; butyl (meth)acrylate; isobutyl (meth)acrylate; 2-ethylhexyl (meth)acrylate; octyl (meth)acrylate; isooctyl (meth)acrylate; isononyl (meth)acrylate; alkyl (meth)acrylate such as lauryl (meth)acrylate; and the like, in which it is allowed for those materials above to be used singularly or by being combined as many as two kinds or more.

For the aforesaid monomer b, there can be cited, for example, phenoxyethyl (meth)acrylate; benzyl (meth)acrylate; styrene; and a monomer having an aromatic ring such as α-methylstyren. It is allowed for those materials above to be used singularly or by being combined as many as two kinds or more.

For the aforesaid monomer c, there can be cited, for example, (meth) acrylic acid; carboxyethyl (meth)acrylate; 2-hydroxyethyl (meth)acrylate; 2-hydroxypropyl (meth)acrylate; 4-hydroxybutyl (meth)acrylate; 6-hydroxyhexyl (meth)acrylate; 8-hydroxyoctyl (meth)acrylate; 10-hydroxydexyl (meth)acrylate; 12-hydroxylauryl (meth)acrylate; hydroxyethyl (meth) acryl amide; and the like.

It is allowed for the aforesaid acrylic-based polymer to be copolymerized by further including a dialkyl substituted acryl amide monomer or an acetoacetyl group contained monomer.

For the dialkyl substituted acryl amide monomer, there can be cited N,N-dimethyl (meth) acryl amide; N,N-diethyl (meth) acryl amide; N-ethyl-N-methyl (meth) acryl amide; N,N-dibutyl (meth) acryl amide; N,N-dipropyl (meth) acryl amide; N,N-diisopropyl (meth) acryl amide; N-methyl N-propylacryl amide; N-methyl N-isopropylacryl amide; and the like. It is preferable to select N,N-dimethyl (meth) acryl amide; N,N-diethyl (meth) acryl amide; and N-ethyl-N-methyl (meth) acryl amide.

For the acetoacetyl group contained monomer, there can be cited acetoacetyl ethylacrylate; acetoacetyl ethylmethacrylate; acetoacetyl ethylcrotonate; acetoacetyl propylacrylate; acetoacetyl propylmethacrylate; acetoacetyl propylcrotonate; 2-cyanoacetoacetyl ethylmethacrylate; N-(2-acetoacetyl ethyl)acryl amide; N-(2-acetoacetyl ethyl)methacrylamide; allylacetoacetate; vinylacetoacetate; and the like. It is preferable to select acetoacetyl ethylacrylate and acetoacetyl ethylmethacrylate.

A polymer is to be synthesized by polymerizing the aforementioned monomers.

For this polymerization method, there can be applied an ordinary solution polymerization, a bulk polymerization, an emulsion polymerization or suspension polymerization, and the like, wherein it is preferable to carry out the production by a solution polymerization in which the aforementioned copolymer is obtained as a solution. According to the fact that the aforementioned copolymer is obtained as a solution, it is possible to use the copolymer directly for the production of the adhesive composition of the present invention. For a solvent used for this solution polymerization, it is possible, for example, to cite an organic solvent such as ethyl acetate, toluene, n-hexane, acetone, methylethylketone or the like.

For a polymerization initiator used for the polymerization, it is possible, for example, to cite a peroxide such as benzoylperoxide and lauroylperoxide, an azobis compound such as azobisisobutyronitrile and azobisvaleronitrile, or a polymer azo polymerization initiator and the like, in which it is possible for those materials to be used singularly or by being combined. Also, for the aforementioned polymerization, it is possible to use a chain-transfer agent, which is publicly-known in the past, in order to adjust the molecular mass of the copolymer.

It should be noted in the aforementioned polymerization that the monomers corresponding to the repeating units which were determined by using the aforementioned method of evaluating the birefringence are polymerized by the aforesaid determined ratio.

The acrylic-based polymer obtained by the polymerization is crosslinked by a crosslinking agent.

For the crosslinking agent for crosslinking the aforementioned acrylic-based polymer, it is possible to use a conventional polyglycidyl compound having glycidyl groups as many as two or more inside one molecule, a polyisocyanate compound having isocyanate groups as many as two or more inside one molecule, a polyaziridine compound having aziridinyl groups as many as two or more inside one molecule, a polyoxazoline compound having oxazoline groups as many as two or more inside one molecule, a metal chelate compound, a butylated melamine compound, or the like. Preferably, it is possible to use the polyisocyanate compound, the polyglycidyl compound, and the metal chelate compound singularly or by being combined as many as two kinds or more in parallel.

For the aforementioned metalchelate compound, there can be cited, for example, a compound in which a polyvalent metal such as aluminum, iron, copper, zinc, tin, titan, nickel, antimony, magnesium, vanadium, chromium and zirconium or the like is coordinated with acetylacetone or ethylacetoacetate, and preferably, there can be cited an alumichelate compound and a titanchelate compound.

For the aforementioned polyisocyanate compound, there can be cited, for example, an isocyanate compound such as tolylenediisocyanate, xylylenediisocyanate, chlorophenylenediisocyanate, hexamethylenediisocyanate, tetramethylenediisocyanate, isophorondiisocyanate, diphenylmethanediisocyanate and an isocyanate compound made by adding those isocyanate compounds with trimethylolpropane or the like; an isocyanurate compound; burette type compound; further, an urethaneprepolymer type isocyanate made by adding & reacting polyetherpolyol, polyesterpolyol, acrylpolyol, polybutadienepolyol, polyisoprenepolyol or the like; and the like.

Caused by the aforementioned crosslinking agent, the crosslink reaction for the acrylic-based polymer makes progress along with time elapse and the content ratio of the crosslink structure increases. If a certain time period elapses, the ratio of the crosslink structure becomes constant.

Also, it is allowed, in advance of the addition of the aforementioned crosslinking agent or on an occasion of the addition of the crosslinking agent, to combine a compound having at least two pieces of aromatic rings inside the molecule.

For the compound having at least two pieces of aromatic rings inside the molecule, there can be cited biphenyl; diphenylsulfone; 4-phenylphenol; benzoin; diphenylsulfide; diphenylether; 4-hydroxybiphenyl-4′-carboxylic acid; 4,4′-biphenol; 4,4′-dihydroxydiphenylmethane; 4-α-cumylphenol; diphenylacetylene; azobenzene; dibenzofuran; diphenylmethane; benzylbenzoate; diphenylphthalete; N-(4-methoxybenzylidene)-4-acetoxyaniline; 4-[(methoxybenzylidene)amino]azobenzene; 4,4′-sulfonyldiphenol; 4-phenoxyphenol; 4′-methoxybenzylideneaminostilbene; bisphenol A; benzylidenephenylamine; N,N′-dibenzylidenehydrazine; transstilbene; p-dianisalbenzidine; terephthalbis-(p-phenetidine); carbazole; 1,4-diphenyl-1,3-butadiene; 1,4-diphenyl-1,3,5-hexadiene; fluorene and dibenzothiophene; diethyleneglycoldibenzoate; dipropyleneglycoldibenzoate; benzylbenzoate; 1,4-cyclohexanedimethanoldibenzoate; tricresylphosphate; trixylenylphosphate; cresyldiphenylphosphate; and 2-ethylhexyldiphenylphosphate.

Even within these compounds, it is more preferable to use at least one kind selected from a group composed of transstilbene, fluorene, diphenylsulfide, benzylbenzoate, dipropyleneglycoldibenzoate, benzoin and diphenylacetylene.

In addition, it is possible for the adhesive agent of the present invention to be used also as a UV crosslink type. For the UV crosslink type adhesive agent, a mono-functional monomer or a multi-functional monomer and a photopolymerization initiator are further added.

It is preferable for the aforementioned monofunctional monomer to have the aromatic ring at least as many as one and specifically, it is preferable to include at least one kind selected from nonylphenyl EO modified acrylate, nonylphenyl PO modified acrylate, 2-hydroxy-3-phenoxypropylacrylate and monohydroxyethylphthalate acrylate.

For the aforementioned multifunctional acrylate, there can be cited ethyleneoxide modified di(meth)acrylate; diacryloxyethylisocyanurate; propyleneoxide modified trimethylolpropanetri(meth)acrylate; tris-acryloxyethyl-isocyanurate; trimethylolpropanetri (meth)acrylate; ε-caprolactone modified tris-acryloxyethyl-isocyanurate; pentaerythritoltetra(meth)acrylate; diglycerintetra(meth)acrylate; propionic acid modified dipentaerythritolpenta(meth)acrylate; caprolactone modified dipentaerythritolhexa(meth)acrylate; and the like, and preferably, there can be cited di or tri (meth) crylate of isocyanurate such as ε-caprolactone modified tris-acryloxyethyl-isocyanurate, diacryloxy-ethyl-isocyanurate and tris-acryloxyethyl-isocyanurate.

For the photopolymerization initiator used for the UV crosslink type adhesive agent, there can be used a conventional photopolymerization initiator by radiation ray (ultraviolet) and, for example, there can be cited aminoketone-based, hydroxyketone-based, acryl-phosphine-oxide-based, benzyl-dimethyl-ketal-based, benzophenone-based initiators, trichloromethyl-group contained triazine derivatives, and the like. Specifically, there can be cited 1-hydroxycyclohexylphenylketone; 2-hydroxy-2-methyl-1-phenylpropane-1-on; 2,4,6-trimethyl-benzoylethoxy-phosphineoxide; α-hydroxyketone; 2,4,6-trimethyl benzophenone; or the like.

It is allowed for the adhesive agent of the present invention to further add other additives thereto. For such an additive, there can be cited an antistatic agent and there is no limitation in particular for the antistatic agent which is applicable. For example, there can be cited a salt formed by a pyridinium-based cation which has an alkyl group of carbon numbers 8 to 16 as a substituent for the nitrogen atom and which has no substituent from α-position to γ-position other than that combined with hexafluorophosphateanion, bis(fluorosulfonyl) imideanion or bis(trifluoromethanesulfonyl) imideanion, and it is preferable to employ an ionic compound in which the electrical conductivity when dissolving 50 wt % toluene is 200 ms/m or more, and it is preferable for the aforesaid pyridinium-based cation to be 1-octylpyridinium, 1-nonylpyridinium, 1-decylpyridinium or 1-undecylpyridinium.

It is possible for the adhesive agent of the present invention to further contain a silane coupling agent. Any one of those silane coupling agents is publicly known in the field of the adhesive agent and it is possible for any one of the publicly-known silane coupling agents to be used in the present invention.

It is allowed for the adhesive agent of the present invention to be combined with a variety of addition agents corresponding to necessary characteristics considering such as an object for adjusting the adhesive force furthermore and the like within a range not damaging the effect of the present invention. For example, it is possible to combine an adhesive application resin such as a terpene-based resin, terpene-phenol-based resin, coumarone-indene-based resin, styrene-based resin, rosin-based resin, xylene-based resin, phenol-based resin, oil-based resin or the like; an antioxidant; an ultraviolet absorber; a filler; a pigment; or the like.

### <Use Application>

In the method of evaluating the birefringence of the adhesive agent according to the present invention, it is possible to measure the birefringence simply and also accurately, so that it is possible for the low-birefringent adhesive agent obtained by utilizing this method to be preferably applied even in any use application if it is a use application in which a thoughtful consideration of the birefringence is necessary. For example, it is possible for the low-birefringent adhesive agent obtained by the method of the present invention to be used for producing a polarizing plate by bonding a polarizing film and a glass substrate together, to be used for producing a liquid crystal display device by bonding a polarizing plate and another member together, and so on.

### <Newly Obtained Knowledges>

The present inventors reached a situation of newly obtaining an important knowledge by a further research & development in addition to the abovementioned knowledge. Hereinafter, there will be explained the newly obtained knowledge.

### (Regarding New Definition of Birefringence)

### 1. Regarding Validity of New Definition of Birefringence

According to “Wikipedia”, there is a description of “the material-property value is a value of expressing the property which the material possesses by a certain scale”. For the melting point, the boiling point and the like, there exists no ambiguity even physically, but they cannot be determined uniquely either unless setting the pressure which the sample receives at the time of the measurement. A lot of other measurable material-property values are values measured under certain measurement conditions and there exist a lot of values whose physical meanings are not accurate so much.

For example, the abovementioned photoelastic coefficient is, usually, defined only by the following [Math. 1] in which even the detailed measurement method thereof is not standardized.

Δn=C_{E}σ [Math. 1]

Therefore, reports based on a lot of interpretations can be found here and there. In view of the present situation about these matters, it can be considered that it is proper for the birefringence measured by the method of measuring the birefringence of the adhesive agent, which was provided by the present inventors, to be defined as a material-property value.

### 2. Regarding Definition of Birefringence Until Now

With regard to the definition of the birefringence until now and difficulty in its application are just as explained in the column of “BACKGROUND ART”. The conclusion derived from those matters lies in a fact that the quantitative evaluation of the birefringence of the adhesive agent was very difficult until now and was substantially impossible, and further, lies in a fact that there was no report until now about such a measurement method & a designing method which can be utilized for the design of the adhesive agent for the liquid crystal display.

It is considered that the prior document or the like which carried out the evaluation of the birefringence based on the definition of the birefringence and which was referred to in the present specification was rejected due to a similar logic as that explicated in the present specification. Therefore, by defining the birefringence measured by the method of measuring the birefringence of the adhesive agent, which is provided in the present specification, as “new birefringence (adhesive's inherent birefringence)”, it is possible to learn a very meaningful material-property value.

### 3. Regarding New Definition of Birefringence

Birefringence measured by a method described below is defined as “adhesive's inherent birefringence”.

### [Measurement Method]

A polymer film whose glass-transition temperature is around 70° C. or more and 110° C. or less, and whose thickness is around 20 μm or more and 100 μm or less is produced in which the orientational birefringence and the photoelastic birefringence do not almost appear.

An adhesive agent which is the measured sample is coated onto the bonding surface of that film. Thereafter, another one sheet of the aforementioned polymer film in which birefringence does not almost appear is bonded together. The layer-thickness of the adhesive agent is made to be around 20 μm or more and 50 μm or less.

Next, in order to one-axially heat-drawing the sample formed by sandwiching the aforementioned adhesive agent by the two sheets of polymer films, the sample is processed into a dumbbell shape.

The sample for evaluation, which was processed into a dumbbell shape, is heated up to the glass-transition temperature or more (glass-transition temperature +5° C. to 30° C.) of the two sheets of polymer films and is one-axially drawn by a drawing speed of 400%/min and a draw ratio of 2.0 times. After drawn, the drawn film is taken out immediately from the apparatus and is cooled by being left as it is under the room temperature. After being left as it is approximately for 24 hours under the room temperature, the retardation (=[birefringence]×[thickness]) inside the film surface is measured. After the retardation measurement, the layer-thickness of the adhesive agent at the measured portion of the sample for evaluation is measured. By dividing the previously measured retardation by the thickness, the birefringence is found.

In the present specification, the birefringence measured by the aforementioned measurement method is referred to as “adhesive's inherent birefringence” and the aforementioned measurement method is referred to as “adhesive's inherent birefringence measurement method (or adhesive's inherent birefringence measurement method)”

The fact that the measurement method of the adhesive's inherent birefringence is suitable for the birefringence measurement of the adhesive agent used for the bonding of the polarizing plate or the like of the liquid crystal display was already described in detail. Hereinafter, the principle of this measurement method seen from the viewpoint of the polymer molecule level will be described.

Generally, an adhesive agent is used for bonding the surface and the surface mutually between a film and a glass substrate, between mutual films, or the like. In order to obtain moderate adhesiveness, usually, the adhesive agent whose glass-transition temperature is sufficiently under the room temperature is used, in which in many cases, the temperature is 0° C. or less. In a case in which the film which was bonded together shrinks, is drawn or the like, a shear stress is added to the adhesive agent by the movement of the bonded surface and the polymer molecules constituting the adhesive agent are oriented toward the shear stress direction. This phenomenon becomes a source of birefringence of the adhesive agent. After the shrinkage & the drawing of the film, the movement of the film stops. However, with regard to the adhesive agent, the glass-transition temperature thereof is sufficiently lower than the room temperature, so that the molecules constituting the oriented adhesive agent are relaxed in a comparatively short time period. In case of the adhesive agent without including the crosslink structure, after the shrinkage & the drawing, the agent is almost relaxed after around 24 hours at the room temperature and there are many cases in which there occurs such a degree of small birefringence which cannot substantially observed. Even in case of the adhesive agent including the crosslink structure, the relaxation of the oriented molecules occurs, but the polymer molecules are relaxed insufficiently more for the adhesive agent in which the content ratio of the crosslink structure is higher and the molecules remain in a state of being oriented to a certain degree. In other words, there occurs a sequential phenomenon such as (orientation of the molecules of the adhesive agent by draw & shrinkage) (relaxation of the molecules of the adhesive agent by being left as they are for 24 hours at the room temperature)=>(appearance of the birefringence by the remaining orientation of the molecules of the adhesive agent). As mentioned in the column of “BACKGROUND ART”, the inherent birefringence can be found if the degree of orientation of the polymer molecules and the birefringence can be measured simultaneously, but it is generally difficult in case of the adhesive agent. However, even in a case in which the degree of orientation of the polymer molecules cannot be found directly, if it is possible to create the equivalent degree of orientation for every sample experimentally and to measure the birefringence thereof, the birefringences of the different kinds of adhesive agents are made to be such material-property values which can be compared quantitatively. This principle becomes the basis of the adhesive's inherent birefringence measurement method.

In view of the principle of the adhesive's inherent birefringence measurement method as described above, it is obvious that there exists a characteristic (dependence on various conditions) which will be described in detail hereinafter and even if the measurement is carried out under a condition somewhat different from the condition in the aforementioned adhesive's inherent birefringence measurement method, it is convertible into a value of the same condition.

### (Dependence on Various Conditions)

Kinds of Curative Agents (Also Referred to as Crosslinking Agents, but Hereinafter, Referred to as Curative Agents)

The birefringence effect is different depending on the curative agent to be used. That is caused by the fact that the crosslink structure formed by the curative agent is different depending on the kind thereof in which the birefringence (polarizability anisotropy) is different, the influence which the orientation behavior gives is different, and the like. The measurement value in the adhesive's inherent birefringence measurement method of the adhesive agent having a certain composition plainly presents the birefringence of the adhesive agent having the composition thereof, so that it is not necessary to carry out the conversion in particular. However, in order to design the adhesive agent whose birefringence is approximately zero such as mentioned by the inventive example 1, it is necessary to measure the birefringences of the adhesive agents having a series of compositions by using the same kind of curative agent.

Curative-Agent Concentration

The birefringence effect is different depending on the curative-agent concentration. Generally, the curative-agent the higher the concentration becomes, the higher the density of the crosslink point becomes, so that there is a tendency that the absolute value of the adhesive's inherent birefringence becomes large. Also with regard to these matters, the adhesive's inherent birefringence of the composition thereof is presented plainly, so that it is not necessary to carry out the conversion in particular. However, in order to design the adhesive agent whose birefringence is approximately zero such as mentioned in the inventive example 1, it is necessary to measure the birefringences of the adhesive agents having a series of compositions by using the curative agent having the same concentration or it is necessary to carry out the conversion so as to be able to make comparison under a condition in which the curative-agent concentration dependence of the adhesive's inherent birefringence is analyzed.

Stretch Ratio

As shown in FIG. 4, if there is applied such a degree of drawing in which the sample is not broken, the birefringence to be measured is different depending on the draw ratio. This shows that the higher the draw ratio is, the higher the degree of orientation of the adhesive-agent polymer becomes and this phenomenon is to ensure the principle of the present measurement method mentioned above. Therefore, it is enough if the birefringence measured by the different draw ratio is made to be the adhesive's inherent birefringence by being converted based on the draw ratio dependence.

Drawing Speed

The degree of orientation of the polymer molecules of the adhesive agent is different depending on the drawing speed, so that the birefringence to be measured is different depending thereon. It is enough if the birefringence measured by the different drawing speed is converted to the adhesive's inherent birefringence based on the drawing speed dependence.

Layer-Thickness of Adhesive Agent

It is desirable for the layer-thickness of the adhesive agent to be around 20 μm or more and 50 μm or less, but if it is around 1000 μm or less, usually, the shear stress is added to the whole adhesive agent layer, so that there is no problem therein.

Glass-Transition Temperature and Drawing Temperature of Polymer Film

It is desirable for the glass-transition temperature of the polymer film to be around 70° C. or more and 110° C. or less. It is desirable for the drawing temperature to be a temperature suitable for the one-axial heat-drawing of these polymer films, usually, to be a temperature which is higher as much as around 5° C. or more and 30° C. or less than the glass-transition temperature. If the glass-transition temperature of the polymer film is a temperature which is sufficiently higher than the room temperature, there is not presented a remarkable shrinkage within around 24 hours after the aforementioned one-axial heat-drawing. Also, at a higher temperature, there occurs a problem easily in which the fluidity of the adhesive agent heightens, the oxidation degradation occurs, or the like. It is possible for the glass-transition temperature of the polymer film to be used even around 50° C. or more and 130° C. or less, but it is desirable to employ a temperature of around 70° C. or more and 110° C. or less.

Birefringence of Polymer Film

In the adhesive's inherent birefringence measurement method, which the present inventors advocate, it is desirable to use a polymer film whose inherent birefringence is 1×10⁻³ or less at the absolute value and whose photoelastic coefficient is 1×10⁻¹² Pa⁻¹ or less by the absolute value. It is possible also to use a polymer film having a larger birefringence, but the measurement accuracy thereof lowers.

Thickness of Polymer Film

From a viewpoint of easiness of the one-axial drawing, it is desirable for the thickness of the polymer film to be around 20 μm or more and 100 μm or less. If it is the thickness of such a degree that the one-axial heat-drawing can be carried out without problem, there is almost no influence to the adhesive's inherent birefringence depending on the difference of the thickness of the polymer film even if the thickness is within the range of the aforementioned thickness or even if the thickness is out of that range.

Molecular Mass of Polymer Film

For the molecular mass of the polymer film, there is no restriction in particular if the aforementioned one-axial heat-drawing is possible and if it is possible to maintain a sufficient intensity after the drawing. Generally, it is desirable to select 80 thousand or more and 150 thousand or less by the weight-average molecular mass.

### [Relation Formula of Adhesive's Inherent Birefringence]

When setting the retardation measured by the aforementioned measurement method of the adhesive's inherent birefringence to be “Re” and setting the layer-thickness of the adhesive agent to be “t”, the adhesive's inherent birefringence “Δn^{ad}” [dimensionless, without having any unit] becomes such as shown in the following formula.

$$\begin{matrix}[ Math . 2 ] & \\ Δ {n}^{ad} = \frac{Re}{t} & ( 1 )\end{matrix}$$

The draw ratio is based on 2.0 times (drawn up to twice the size of the original sample and the ratio is measured by an interval of the gauge lines marked at the dumbbell shaped sample). The proportional relation is confirmed between the draw ratio and the birefringence, so that when the correction term thereof is introduced into the formula (1), a formula (2) will be obtained as follows.

$$\begin{matrix}[ Math . 3 ] & \\ Δ {n}^{ad} = Re / tx 2 / DR & ( 2 ) \\ Δ {n}^{ad} = \frac{Re}{t} \times \frac{2}{DR} & ( 2 )\end{matrix}$$

Here, DR means the draw ratio.

### <Consideration Regarding Newly Obtained Knowledges, Etc.>

Next, it will be considered newly again from a plurality of viewpoints with regard to the knowledges or the like which the present inventors have newly obtained.

### 1. Measurement Method of Birefringence of Adhesive Agent

Trials of aiming at picture-quality improvement of various kinds of displays by making the birefringence of an optical film small have been carried out by various kinds of ways. For the evaluation method thereof, the designing of the optical film is carried out by measuring the inherent birefringence (orientational birefringence) and the photoelastic coefficient of the film.

However, the optical film is bonded by an adhesive agent in a liquid crystal display, a PDP or the like and it is conceivable that the birefringence of the adhesive agent affects the picture quality of the display largely, but until now, there has been no consideration about the birefringence of the adhesive agent. For this matter, there can be pointed out one reason that it was not possible to measure the birefringence of the adhesive agent accurately.

The present inventors reached a success in measuring the birefringence of the adhesive agent accurately. As for this example, it is possible to cite, for example, the inventive examples 5, 6. Also, such as the relation between the draw ratio and the adhesive's inherent birefringence shown in FIG. 4, there is shown that the higher the draw ratio is, the higher the degree of orientation of an adhesive-agent polymer becomes, and this phenomenon is to ensure the principle of the present measurement method.

The present measurement method and a conventional birefringence measurement method until now are shown in Tables while being compared.

TABLE A
Birefringence Value of Polymer

| | | Deformation | Measurement | | |
|---|---|---|---|---|---|
| | Variables | Temperature | Temperature | Crosslink | Use Application |
| Stress Optical | tension | TG or more | TG or more | NO | birefringence |
| Coefficient | | | | | at the time of |
| | | | | | fusion & fiber- |
| | | | | | forming |
| Inherent | degree of | TG or more | TG or less | NO | birefringence |
| Birefringence | orientation | | | | after fusion & |
| (Orientation | (degree of | | | | fiber-forming |
| Birefringence) | deformation) | | | | |
| Photoelastic | tension & | TG or less | TG or less | NO/YES | birefringence |
| Coefficient | degree of | | | | at the time of |
| | deformation | | | | adding stress |
| | | | | | to molded |
| | | | | | product |
| Adhesive's | degree of | TG or more | TG or more | NO/YES | birefringence |
| Inherent | deformation | | | | after applying |
| Birefringence | | | | | stress to |
| | | | | | adhesive-agent |

As for other variables, there exist thickness, deformation speed and the like.

2. Designing Method with Respect to Birefringence of Adhesive Agent

Owing to the fact that the measurement method of the birefringence was established by the research of the present inventors, it was comprehended that the adhesive's inherent birefringence changes depending on various kinds of factors under a situation of designing the adhesive agent.

### (1) Copolymer Composition

The adhesive's inherent birefringence is different depending on the kinds of repeating units (monomers) constituting the adhesive-agent polymer. The birefringence can be adjusted by adjusting the kinds and the ratio of these repeating units (monomers) of two kinds or more, whose birefringences are different. It was comprehended that those of the adhesive's inherent birefringence and the ratio of the monomers have a first-order interrelation.

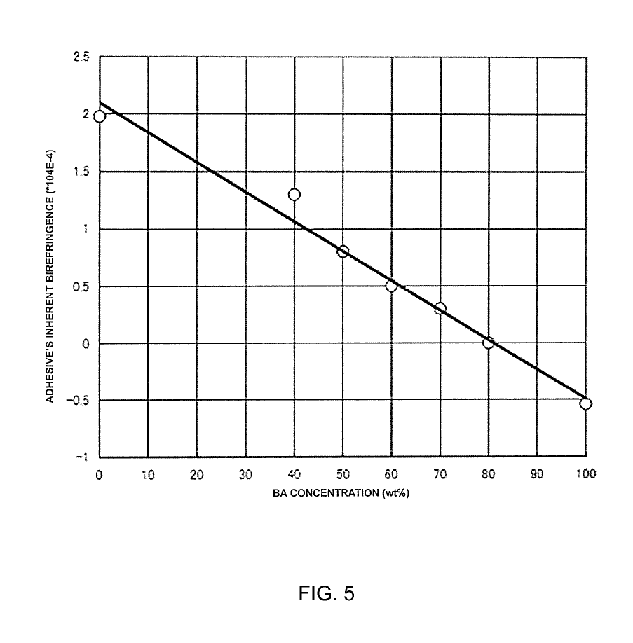

For this example, it is possible to cite, for example, inventive examples 1-7 to 1-13. The first-order interrelation is shown also for the BA concentration and the adhesive's inherent birefringence in FIG. 5.

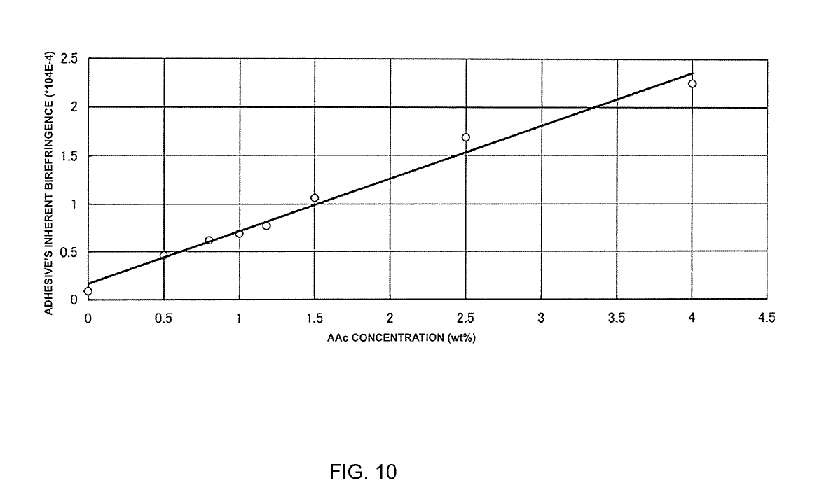

FIG. 10 is a diagram showing a relation between AAc concentration and adhesive's inherent birefringence in case of an inventive example 7.

Further, it is possible to design an adhesive-agent polymer whose adhesive's inherent birefringence becomes zero by copolymerizing a monomer which becomes a polymer showing positive adhesive's inherent birefringence and a monomer which becomes a polymer showing negative adhesive's inherent birefringence.

### (2) Influence of Addition Agent (Additive)

The adhesive agent is designed by adding various kinds of addition agents (compounds having at least two pieces of aromatic rings in the molecule) to the main polymer, and it became clear that the adhesive's inherent birefringence can be adjusted by the kinds and the amounts of these addition agents. Further, it was comprehended that the adhesive's inherent birefringence has the first-order correlation with respect to the additive amount of the additive.

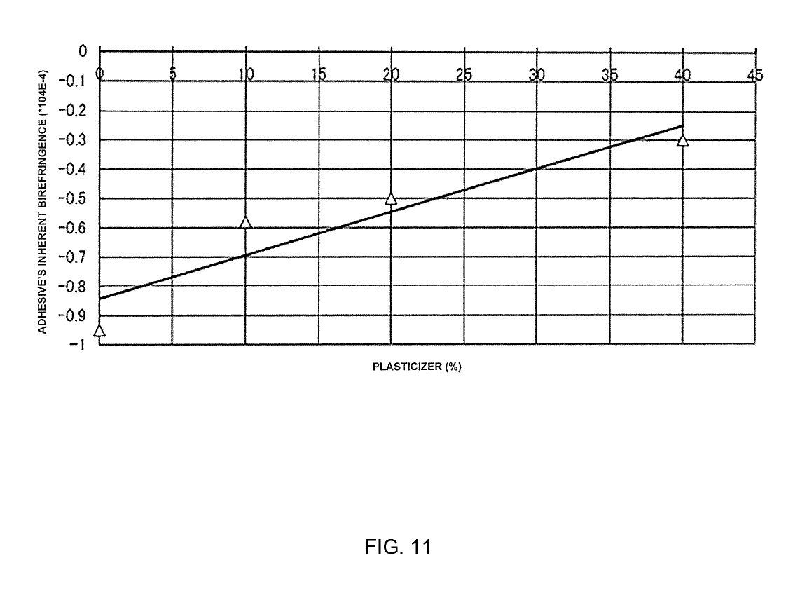

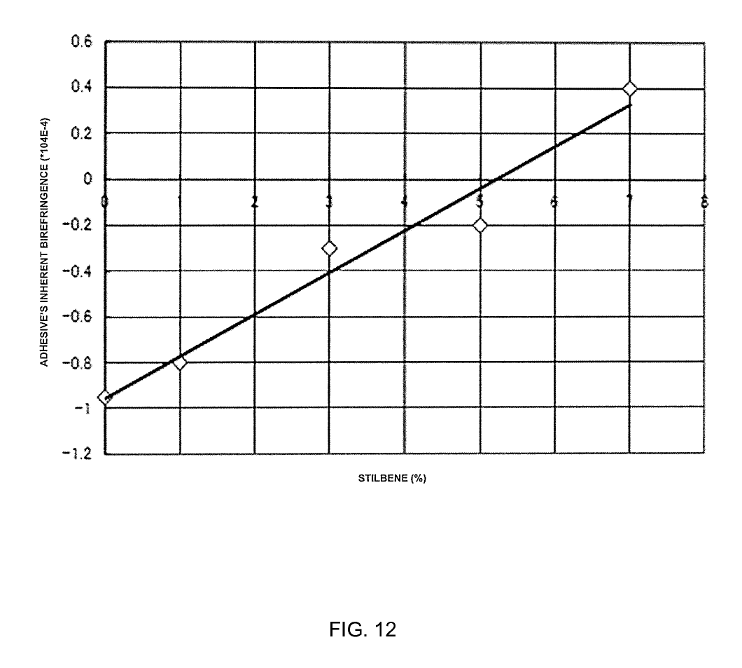

FIG. 11 is a diagram showing a relation between a plasticizer (benzylbenzoate) and adhesive's inherent birefringence in case of an inventive example 8. FIG. 12 is a diagram showing a relation between trans-stilbene and adhesive's inherent birefringence in case of an inventive example 9.

Further, it is possible to make the adhesive's inherent birefringence be zero by compounding a compound showing opposite birefringence into a polymer showing positive or negative adhesive's inherent birefringence.

### (3) Influence of Curative Agent

It was comprehended that the adhesive's inherent birefringence can be adjusted by the kind and the amount of the curative agent.

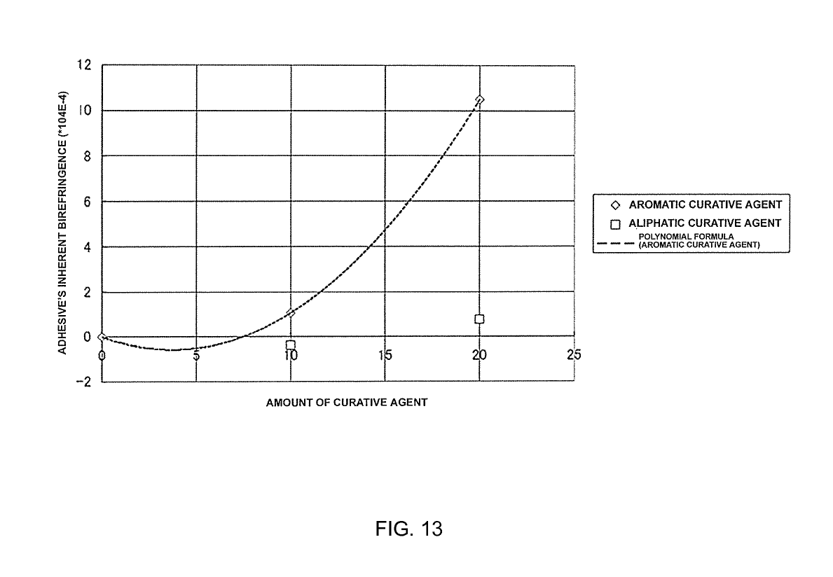

FIG. 13 is a diagram showing a relation between amount of curative agent and adhesive's inherent birefringence in case of an inventive example 10.

Further, it is possible to make the adhesive's inherent birefringence be zero by compounding various kinds of curative agents into a polymer showing positive or negative adhesive's inherent birefringence.

In addition, also with regard to an adhesive agent of an ultraviolet or electron beam curing type, it is possible to make the adhesive's inherent birefringence be zero by adjusting the adhesive's inherent birefringence. For this example, it is possible to cite, for example, an inventive example 11.

In a range in which the amount of the curative agent is 0 or very little, it was comprehended that the adhesive's inherent birefringence is approximately zero. It is conceivable that this phenomenon is caused by the fact that since the glass-transition temperature (TG) of the adhesive agent is very low compared with the measurement temperature (23° C.) of the adhesive's inherent birefringence and the temperature (102° C.) to be drawn, the orientation or the like of the polymer when the adhesive agent is deformed is relaxed at once, so that the adhesive's inherent birefringence does not appear.

However, in the range in which the amount of the curative agent is 0 or very little, the cohesive force and the heat-resisting property of the adhesive agent are not obtained so much, so that there is a shortcoming in the use as an optical adhesive agent.

### 3. Physical Property of Adhesive Agent

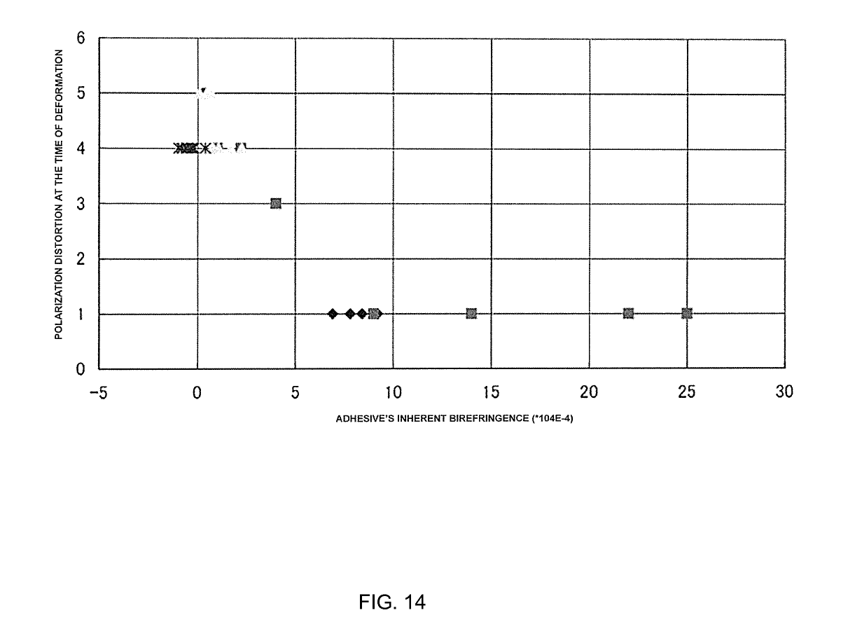

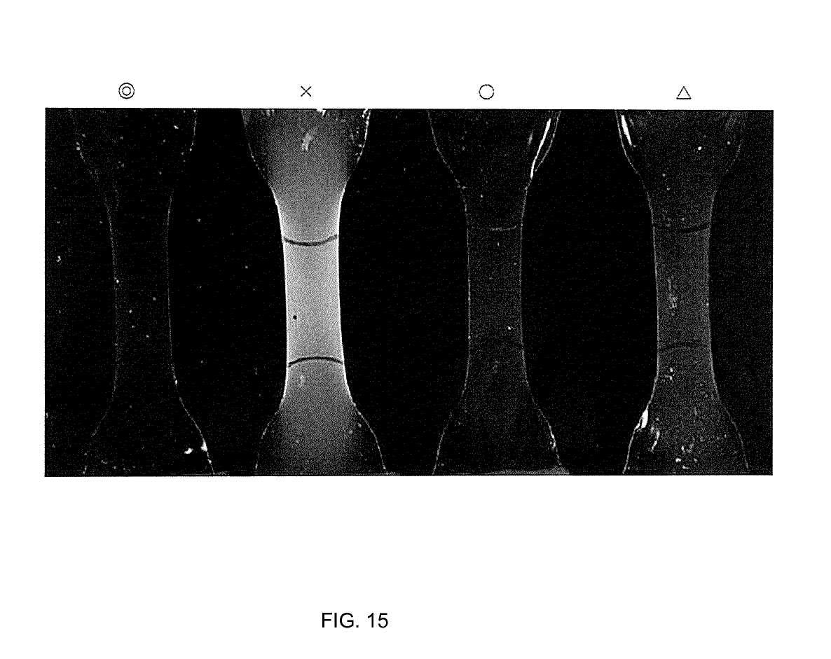

(1) FIG. 14 is a diagram showing a relation between adhesive's inherent birefringence and distortion of polarization state at the time of deformation. FIG. 15 is a diagram showing an evaluation example of the distortion of polarization state.

With regard to the adhesive agent, the distortion of polarization state (light leakage) at the time of deformation is very small. From the drawing, it was comprehended that it is preferable to employ an adhesive agent in which the absolute value of the adhesive's inherent birefringence is 4×10⁻⁴ or less. In addition, it also became clear that it is more preferable to employ an adhesive agent in which the absolute value of the adhesive's inherent birefringence is 2×10⁻⁴ or less.

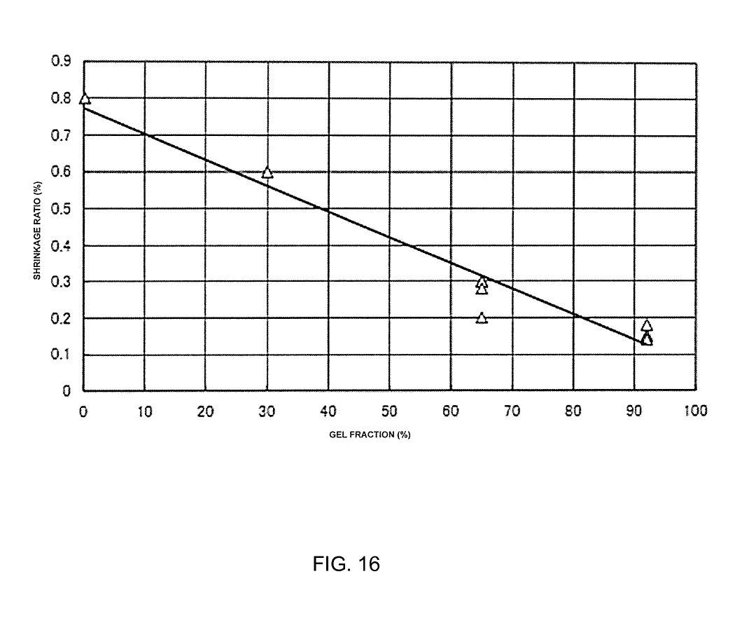

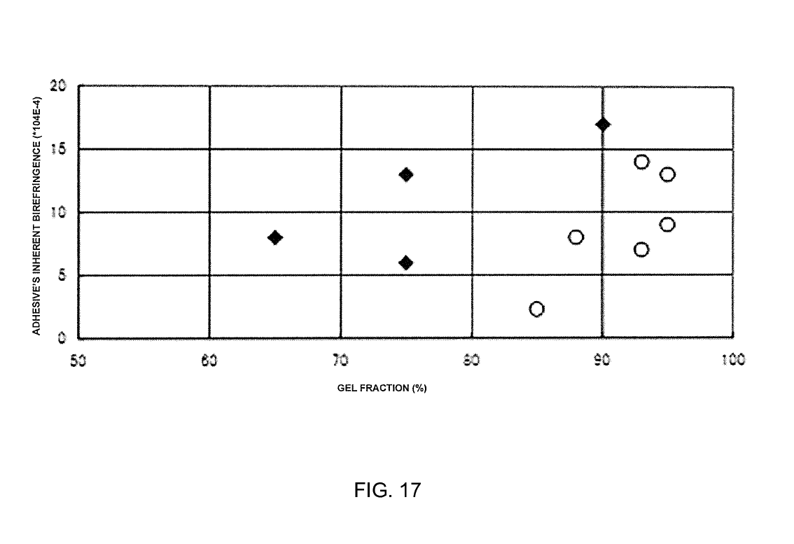

(2) FIG. 16 is a diagram showing a relation between gel fraction (gel fraction %) and shrinkage ratio in case of an inventive example 3 or the like. FIG. 17 is a diagram showing a relation between gel fraction and adhesive's inherent birefringence in case of an inventive example 12.

With regard to the adhesive agent whose gel fraction (gel fraction %) is small, the shrinkage ratio of the polarizing plate becomes large, so that the amount of deformation of the adhesive agent becomes large and with regard to the adhesive agent whose adhesive's inherent birefringence is large, the birefringence thereof becomes large and the light leakage is bad. The shrinkage ratio is small in the condition in which the gel fraction is 80% or more, so that also the amount of deformation of the adhesive agent is small and even if the adhesive's inherent birefringence is large to a certain degree, the light leakage is preferable. From the drawings, it is comprehended that it is preferable to employ an adhesive agent in which the gel fraction (%) is 80% or more and the absolute value of the adhesive's inherent birefringence is 15×10⁻⁴ or less. In addition, it became also clear that it is more preferable to employ an adhesive agent whose gel fraction is 85% or more.

### 4. Use Application of Low Birefringence-Index Adhesive Agent

Here, in consideration of the newly obtained knowledge, there will be explained a preferable use application newly again.

### 1) Polarizing Plate Use

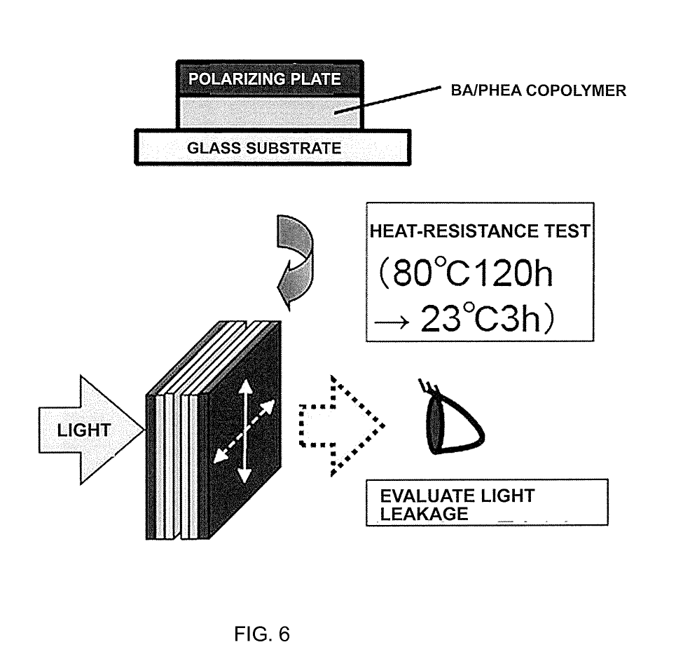

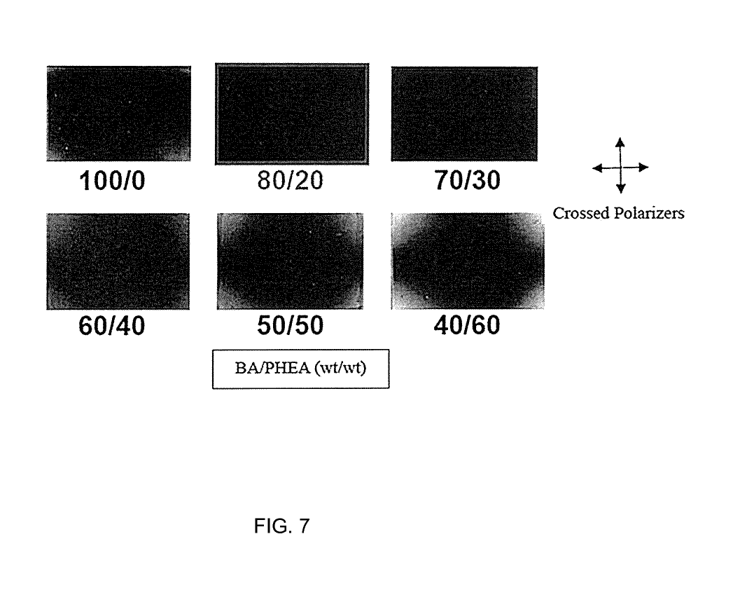

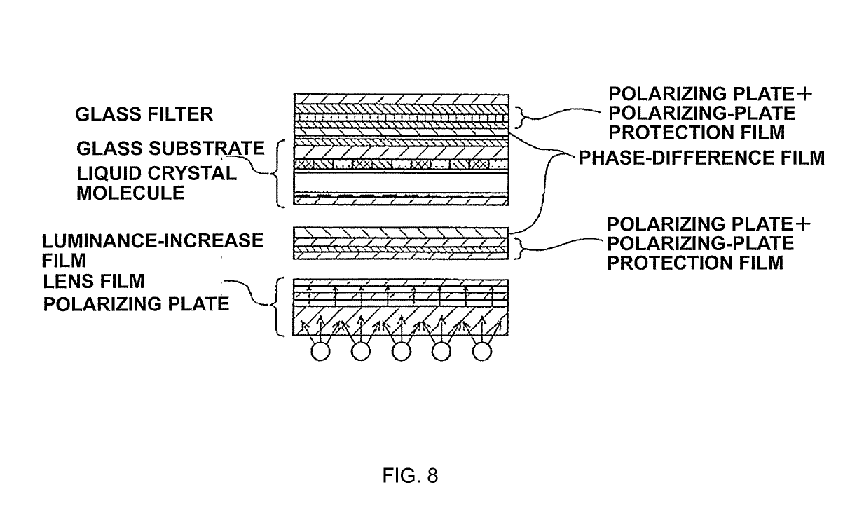

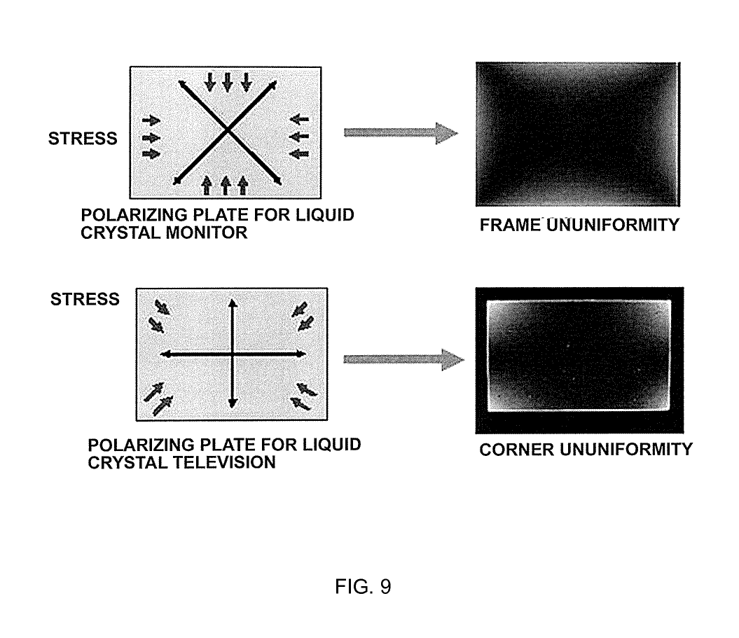

For the polarizing plate use, the shrinkage of the polarizing plate caused by the changes in the temperature and the humidity becomes large by the fact that the liquid crystal panel is designed to be large, so that the deformation of the adhesive agent becomes large and the distribution of the birefringence depending on the position of the adhesive agent becomes large. Consequently, the ununiformity of the light leakage on an occasion of the “black” display for the liquid crystal panel becomes large. This phenomenon is suggested also from FIG. 6, FIG. 7, FIG. 8 and FIG. 9.

### 2) Touch Panel, PDP, Front Panel of Liquid Crystal Display

In a lot of display, various kinds of films are bonded together by an adhesive agent.

(1) The deformation of the film by the changes of the temperature and the humidity is caused by the fact of being designed to be large, so that the display quality of the picture screen deteriorates when the distribution of the birefringence depending on the position becomes large for each of the film and the adhesive agent.
(2) It is necessary to make the thickness of the adhesive agent thick for the shock absorption of the panel and for filling-in the step. The thickness of the adhesive agent, which is 25 μm usually, is made to be 50 μm or more and 200 μm or less. The birefringence becomes large in proportion to the thickness of the adhesive agent, so that the change of the birefringence depending on the distribution of the thickness and the distribution of the stress becomes large. For this example, it is possible to cite an inventive example 13.

### 3) Adhesive Agent Alternative for Polarizer Protection Film

The polarizer protection film of TAC or the like until now becomes unnecessary and cost reduction can be realized.

A large deformation is applied to the adhesive agent by the shrinkage of the polarizer, so that for a conventional adhesive agent, the birefringence thereof becomes large partially and the light leakage caused by the ununiformity or the like becomes remarkable. For this example, it is possible to cite an inventive example 14.

### 5. Advantageous Effect Conceivable in Each Use-Application

### 1) Effect of Low-Birefringent Adhesive Agent

The adhesive agent is processed by approximately 25 μm for the dry thickness, but fluctuation of the thickness depending on the position in the sheet occurs as much as around ±2 μm. The birefringence is in proportion to the thickness, so that in a case in which the birefringence of the adhesive agent itself is large, the fluctuation of the thickness depending on the position in the sheet occurs as much as ±10%.

However, with regard to the low-birefringent adhesive agent, the fluctuation value of the birefringence becomes small.

2) Advantageous Effect by Combination of Zero Birefringent Adhesive Agent (Adhesive Agent in which Absolute Value of Adhesive's Inherent Birefringence is 4×10⁻⁴ or less) and Zero-Zero Birefringent Polymer Film (Described in Inventive Example 1)

Since the orientational birefringence of the zero-zero birefringent film is close to zero when applied with a fusing process, it can be produced with low cost by a push-out process. However, since the fluctuation of the thickness of the film in the push-out process becomes large compared with that in the solvent casting method, the fluctuation of the total thickness becomes very large when combining the push-out processed film and the adhesive agent, so that the fluctuation of the birefringence depending on the position in the sheet of the birefringence becomes large.

By combining the zero birefringent adhesive agent and the zero-zero birefringent film, the fluctuation of the birefringence caused by the fluctuation of the thickness of the combination of both the sides becomes small in addition to the fact that the birefringence with respect to the respective deformations becomes small. For this example, it is possible to cite an inventive example 15.

### <Regarding Constitution Using Zero-Zero Birefringent Polymer>

Here, the zero-zero birefringence polymer means a polymer in which both of the orientational birefringence and the photoelastic birefringence are approximately zero. This matter is described in the literary document, for example, Akihiro Tagaya, Hisanori Ohkita, Tomoaki Harada, Kayoko Ishibashi, and Yasuhiro Koike, “Zero-Birefringence Optical Polymers”, Macromolecules, 39, pp. 3019-3023 (2006), or the like. Within the plurality of zero-zero-birefringence polymers described in this literary document, for example, with regard to poly (methyl methacrylate (MMA)/2,2,2-trifluoroethyl methacrylate (3FMA)/benzyl methacrylate) 52.0/42.0/6.0 (w/w/w)), the inherent birefringence thereof is approximately zero and even if being heat-drawn, the orientational birefringence thereof almost does not occur and the photoelastic coefficient is around 0.119×10⁻¹² Pa⁻¹, and the birefringence almost does not appear even if applying the stress thereto at a temperature equal to or less than the glass-transition temperature. It is a magnitude which can be regarded as approximately zero in an ordinary birefringence measuring apparatus. Also, the glass-transition temperature is approximately 90° C.

By the stress applied to the polarizing plate at the time of the shrinkage of the polarizing plate, the photoelastic birefringence occurs in the polarizing-plate protection film or in the phase-difference film, which is constituting the polarizing plate. In case of the polarizing-plate protection film, generally, a film having a low birefringence is used. However, the polarizing-plate protection film, which includes triacetylcellulose as a main component and which is used most broadly, has photoelastic coefficient of around 12.0×10⁻¹² Pa⁻¹, and is a film in which it is easy for the photoelastic birefringence to occur as much as approximately 100 times compared with the film composed of the aforementioned zero-zero birefringence polymer. Therefore, if using a polarizing-plate protection film composed of the zero-zero birefringence polymer, the photoelastic birefringence by the polarizing-plate protection film constituting the polarizing plate at the time of the shrinkage becomes approximately zero, and if an adhesive agent to be used is an adhesive agent provided by the present application, the birefringence by the adhesive agent becomes approximately zero and it becomes a constitution in which the birefringence is the smallest (close to zero) as a total.

The characteristic referred to as “orientational birefringence does not occur”, which is from another “zero” of the zero-zero-birefringence polymer film, becomes an advantage at the time of the film production. The orientational birefringence appears by the fact that a chain shaped molecules chain is oriented, so that, generally, the polarizing-plate protection film is produced by a solution salivation film-forming method. Recently, in order to improve the production efficiency more, a fusing extrusion method in which a solvent is not used is going to be employed. In this method, it is easy for the polymer-molecule chain to be oriented, so that there occur many cases in which the setting of the production condition for repressing the orientation of the polymer-molecule chain leads to a phenomenon in which the production efficiency is damaged. Therefore, it is expected that the zero-zero birefringence polymer in which the birefringence does not occur even if being oriented will largely contribute for the improvement of the production efficiency of the low birefringent polarizing-plate protection film.

In view of these matters, in the combination with the adhesive agent having the low birefringence which the present application proposes with respect to such an object that the birefringence caused by the stress at the time of the polarizing plate shrinkage is to be minimized (made closer to zero), it is comprehended that the zero-zero-birefringence polymer film is a suitable film, but even if the orientational birefringence is not necessarily selected to be zero, a desirable constitution can be obtained if the absolute value of the photoelastic coefficient is 8×10⁻¹² Pa⁻¹ or less. This is because, if being roughly estimated from only the photoelastic coefficient, the photoelastic birefringence can be suppressed within around three quarters compared with that of the film (around 12.0×10⁻¹² Pa⁻¹) in which triacetylcellulose which is used most broadly is made to be a main component. It is more desirable for the absolute value of the photoelastic coefficient to be 5×10⁻¹² Pa⁻¹ or less and it is still more desirable to be 3×10⁻¹² Pa⁻¹ or less. It is because if the polymer film in which the degree of the orientation of the polymer-molecule chain is low is obtained by a solution salivation film forming method, a fusing extrusion method of low speed or the like, the photoelastic birefringence becomes a problem when being used.

According to a literary document “Zero-Birefringence Optical Polymers” by Akihiro Tagaya, Hisanori Ohkita, Tomoaki Harada, Kayoko Ishibashi, and Yasuhiro Koike, Macromolecules, 39, pp. 3019-3023 (2006), or the like, it was reported that by copolymerizing respective monomers constituting homopolymers whose photoelastic birefringences (photoelastic coefficient) are positive and negative, there can be obtained a polymer having a low photoelastic birefringence (small photoelastic coefficient). It is known that an additive property is realized between a photoelastic coefficient C of the obtained polymer (copolymer) and a photoelastic coefficient Ci of each homopolymer i corresponding to the used i-th monomer type. Specifically, the photoelastic coefficient C of n-block copolymer becomes as follows.

$$\begin{matrix}[ Math . a ] & \\ C = {\sum }_{n = 1}^{n} {C}_{i} \times {a}_{i} = {C}_{1} \times {a}_{1} + {C}_{2} \times {a}_{2} + … + {C}_{n} \times {a}_{n} & ( a )\end{matrix}$$

Here, ai means composition ratio inside the copolymer of the monomer type i constituting the i-th homopolymer type. Therefore, the formula (a) becomes as follows.

$$\begin{matrix}[ Math . b ] & \\ {\sum }_{n = 1}^{n} {a}_{i} = {a}_{1} + {a}_{2} + … + {a}_{n} = 1 & ( b )\end{matrix}$$

In a binary copolymer, the formula becomes as follows:

[Math. c]

C=C₁×a₁+C₂×a₂ (c)

[Math. d]

a₁+a₂=1 (d)

In addition, in a ternary copolymer, the formula becomes as follows.

[Math. e]

C=C₁×a₁+C₂×a₂+C₃×a₃ (e)

[Math. f]

a₁+a₂+a₃=1 (f)

Hereinafter, there will be described examples of specific monomers (alphameric characters inside the “bracket [ ]” corresponds to photoelastic coefficient of homopolymer), but it is not necessarily limited by these alphameric characters. In addition, it does not depend on the polymerization method, either.

Monomers showing positive photoelastic birefringence are as follows:

Benzylmethacrylate [48.4×10⁻¹² Pa⁻¹]

Dicyclopentadienylmethacrylate [6.7×10⁻¹² Pa⁻¹]

Styrene [10.1×10⁻¹² Pa⁻¹]

P-chlorostyrene [29.0×10⁻¹² Pa⁻¹]

Monomers showing negative photoelastic birefringence are as follows:

Methylmethacrylate [−4.3×10⁻¹² Pa⁻¹]

2,2,2-trifluoroethylmethacrylate [−1.7×10⁻¹² Pa⁻¹]

2,2,2-trichloroethylmethacrylate [−10.2×10⁻¹² Pa⁻¹]

Isobornylmethacrylate [−5.8×10⁻¹² Pa⁻¹]

For example, when carrying out the calculation by using the formula (b) with regard to di-copolymerization-based material of methylmethacrylate (MMA) and benzylmethacrylate (BzMA), the composition which satisfies the absolute value 8×10⁻¹² Pa⁻¹ or less of the aforementioned photoelastic coefficient becomes a poly (MMA/BzMA=100/0 or more and 77/23 or less (wt %/wt %)). Further, the composition which satisfies the absolute value 5×10⁻¹² Pa⁻¹ or less of the photoelastic coefficient becomes a poly (MMA/BzMA=100/0 or more and 83/17 or less (wt %/wt %)), and the composition which satisfies the absolute value 3×10⁻¹² Pa⁻¹ or less of the photoelastic coefficient becomes a poly (MMA/BzMA=97/3 or more and 87/13 or less (wt %/wt %)).

Di-copolymerization-based polymers synthesized by the compositions in those ranges may become promising candidates and in particular, with regard to the composition in the vicinity of the poly (MMA/BzMA=82/18 (wt %/wt %)), the orientational birefringence thereof becomes approximately zero and with regard to the composition in the vicinity of the poly (MMA/BzMA=92/8 (wt %/wt %)), the photoelastic birefringence thereof becomes approximately zero, so that these compositions become very promising. Also, the composition among those ranges becomes a composition in which both the birefringences are reduced in a well-balanced condition, so that the composition is promising.

As clear also from the example of the aforementioned zero-zero-birefringence polymers, it is possible to carry out the calculation also from three or more of monomer types by using the formula (a), and it is possible to employ a variety of combinations for the combination of the positive & negative monomer types.

In addition, also for the phase-difference film, it is comprehended that it becomes a desirable constitution if the absolute value of the photoelastic coefficient is around 8×10⁻¹² Pa⁻¹ or less. It is more desirable for the absolute value of the photoelastic coefficient to be 5×10⁻¹² Pa⁻¹ or less, and it is still more desirable to be 3×10⁻¹² Pa⁻¹ or less. Therefore, it becomes also desirable to employ a combination with a commercially available phase-difference film having a low photoelastic birefringence.

<Influence of Layer-Thickness of Adhesive Agent onto Adhesive's Inherent Birefringence>

As a result of finding out the adhesive's inherent birefringences by using samples of the adhesive agents having layer-thicknesses 5 μm, 10 μm, 25 μm, 50 μm, 100 μm according to the method provided by this exemplified example, it was confirmed that there exists dependence on the layer-thickness of the adhesive agent. In this method, by the fact that the films sandwiching the adhesive agent layer are expanded by the drawing, a shear stress occurs and polymer molecules constituting the adhesive agent are oriented. When the layer-thickness of the adhesive agent is different, the distance between the two sheets of the films becomes different and as the result thereof, the shear stress applied to each portion of the adhesive agent layer becomes different. Therefore, the degree of orientation of the polymer molecules of each portion of the adhesive agent layer is different and the birefringence which occurs as the result thereof becomes different.

Generally, in case of applying a shear stress to a viscous fluid body, the magnitude of the shear stress has a relation in inverse proportion to the distance between the films in this evaluation method. The adhesive agent includes the crosslink structure, so that for the adhesive agent used at this time, in which there is also an aspect different from that of an ordinary viscous fluid body, there was obtained a relation approximately as follows, in which A, B are constants.

[Birefringence]=A/[thickness of adhesive agent before draw]+B

A and B are constants inherent to the respective adhesive agents and it is possible for each sign thereof to be positive or negative. Therefore, difficulty is involved for presenting a simple general-formula with regard to that dependence. Also, the thinner the layer-thickness of the adhesive agent becomes, the larger the shear stress applied to the adhesive agent becomes and there easily occurs such a defect that the adhesive agent layer is broken, is peeled or the like. In the evaluation this time, the layer was broken & peeled for 5 μm and it was not possible to carryout the evaluation thereof, but there was no problem for 10 μm or more.

From the knowledge described above, it can be guessed that there exists a preferable thickness for the adhesive agent layer when carrying out the evaluation in this evaluation method. For one example of the numerical value thereof, it is possible to cite approximately 30 μm which is described in the inventive example 1. Further, even in a case in which the evaluation was carried out based on the layer-thickness of the adhesive agent other than this thickness, it became clear that there exists the dependence on the film thickness in which the larger the film thickness becomes, the smaller the absolute value of the birefringence becomes, in which it can be found out experimentally if required and it is not changed so largely within the range between 25 μm or more and 35 μm or less.

<Influence of Drawing Speed onto Adhesive's Inherent Birefringence>

As the result of having carried out the drawing in the range of 100% to 600%/min of the drawing speeds, there was recognized no drawing temperature dependence of the adhesive's inherent birefringence. It can be guessed that this is caused by the fact that the glass-transition temperature of the adhesive agent is considerably lower than the drawing temperature and the fluidity of the adhesive agent at the time of the drawing is very high. It can be considered that there is no large difference even for the drawing speed out of that range.

The adhesive's inherent birefringence does not have a large dependence with respect to the drawing speed, but from a viewpoint of easiness of reproducibility & evaluation or the like, it is desirable for the drawing to be carried out depending on the drawing speed of 50% or more and 1000% or less per minute and it is more desirable to be carried out by the drawing speed of 100% or more and 600% or less per minute.

### <Material-Property Values of Various Kinds of Inventive Examples>

Hereinafter, there are presented Tables showing material-property values of various kinds of inventive examples. The material-property values presented in the tables were shown in the drawings properly.

TABLE B

| | Inventive Example 1 | | | | | | |
|---|---|---|---|---|---|---|---|
| | Ex. 1-1 | Ex. 1-2 | Ex. 1-3 | Ex. 1-4 | Ex. 1-5 | Ex. 1-6 | Ex. 1-7 |
| BA | 100 | | | | | | 100 |
| MA | | | | 100 | | 100 | |
| PHEA | | 100 | | | | | 0 |
| EA | | | 100 | | 100 | | |
| AAc | 1.5 | 1.5 | 1.5 | 1.5 | 1.5 | 1.5 | 1.5 |
| HEA | 1 | 1 | 1 | 1 | 1 | 1 | 1 |
| MW (thousand) | 1500 | 1500 | 1500 | 1500 | 1500 | 1500 | 1500 |
| Solid Fraction (%) | 15 | 15 | 15 | 15 | 15 | 15 | 15 |
| | Curative | Curative | Curative | Curative | Curative | Curative | Curative |
| | Agent A | Agent A | Agent A | Agent A | Agent B | Agent B | Agent B |
| Gel Fraction (%) | 90 | 95 | 93 | 90 | 65 | 65 | 65 |
| TG (° C.) | −56 | −22 | −22 | 3 | −22 | 3 | −56 |
| Adhesive's Inherent | 2.17 | 16.7 | 3.32 | 6.38 | −0.65 | −1.06 | −0.54 |
| Birefringence (*10E−4) | | | | | | | |
| Refractive Index (25° C.) | 1.482 | 1.562 | 1.486 | 1.496 | 1.47 | 1.48 | 1.465 |
| Polarization Distortion | ◯ | X | ◯ | Δ | ◯ | ◯ | ◯ |
| at the time of | | | | | | | |
| Deformation | | | | | | | |
| Polarization Distortion | 4 | 1 | 4 | 3 | 4 | 4 | 4 |
| at the time of | | | | | | | |
| Deformation (Numerical | | | | | | | |
| Value) | | | | | | | |

| | Inventive Example 1 | | | | | |
|---|---|---|---|---|---|---|
| | Ex. 1-8 | Ex. 1-9 | Ex. 1-10 | Ex. 1-11 | Ex. 1-12 | Ex. 1-13 |
| BA | 80 | 70 | 60 | 50 | 40 | 0 |
| MA | | | | | | |
| PHEA | 20 | 30 | 40 | 50 | 60 | 100 |
| EA | | | | | | |
| AAc | 1.5 | 1.5 | 1.5 | 1.5 | 1.5 | 1.5 |
| HEA | 1 | 1 | 1 | 1 | 1 | 1 |
| MW (thousand) | 1500 | 1500 | 1500 | 1500 | 1500 | 1500 |
| Solid Fraction (%) | 15 | 15 | 15 | 15 | 15 | 15 |
| | Curative | Curative | Curative | Curative | Curative | Curative |
| | Agent B | Agent B | Agent B | Agent B | Agent B | Agent B |
| Gel Fraction (%) | 65 | 65 | 65 | 65 | 65 | 65 |
| TG (° C.) | −48 | −45 | −42 | −38 | −35 | −22 |
| Adhesive's Inherent | 0 | 0.3 | 0.5 | 0.8 | 1.3 | 1.98 |
| Birefringence (*10E−4) | | | | | | |
| Refractive Index (25° C.) | 1.483 | 1.491 | 1.5 | 1.509 | 1.518 | 1.555 |
| Polarization Distortion | ⊚ | ⊚ | ◯ | ◯ | ◯ | ◯ |
| at the time of | | | | | | |
| Deformation | | | | | | |
| Polarization Distortion | 5 | 5 | 4 | 4 | 4 | 4 |
| at the time of | | | | | | |
| Deformation (Numerical | | | | | | |
| Value) | | | | | | |

TABLE C

| | Ex. 2-1 | Ex. 2-2 | Ex. 2-3 | Ex. 2-4 | Ex. 3 | Ex. 4 |
|---|---|---|---|---|---|---|
| BA | 80 | 80 | 50 | 80 | 80 | 100 |
| MA | 20 | 20 | 50 | | 20 | |
| PHEA | | | | 20 | | |
| EA | | | | | | |
| AAc | 3 | 3 | 3 | 3 | | |
| 4HBA | | | | | 1 | 0.1 |
| MW (thousand) | 800 | 1500 | 1500 | 1800 | 600 | 400 |
| Solid Fraction | 30 | 15 | 15 | 15 | 15 | 15 |
| (%) | | | | | | |
| | Curative | Curative | Curative | Curative | Curative | Curative |
| | Agent C | Agent C | Agent C | Agent C | Agent E | Agent E |
| Gel Fraction (%) | 92 | 92 | 92 | 92 | 30 | 0.2 |
| TG (° C.) | −40 | −40 | −25 | −40 | −40 | −55 |
| Adhesive's | 6.9 | 7.8 | 8.4 | 9.2 | 0.4 | 0.27 |
| Inherent | | | | | | |
| Birefringence | | | | | | |
| (*10E−4) | | | | | | |
| Refractive Index | 1.48 | 1.48 | 1.49 | 1.483 | 1.465 | 1.465 |
| (25° C.) | | | | | | |
| Polarization | X | X | X | X | ⊚ | ⊚ |
| Distortion at | | | | | | |
| the time of | | | | | | |
| Deformation | | | | | | |
| Polarization | 1 | 1 | 1 | 1 | 5 | 5 |
| Distortion at | | | | | | |
| the time of | | | | | | |
| Deformation | | | | | | |
| (Numerical | | | | | | |
| Value) | | | | | | |

TABLE D

| | Ex. 5-1 | Ex. 5-2 | Ex. 5-3 | Ex. 5-4 | Ex. 5-5 | Ex. 6-1 | Ex. 6-2 | Ex. 6-3 |
|---|---|---|---|---|---|---|---|---|
| BA | | | | | | 100 | 100 | 100 |
| PHEA | 100 | 100 | 100 | 100 | 100 | | | |
| EA | | | | | | | | |
| AAc | 1.5 | 1.5 | 1.5 | 1.5 | 1.5 | 1.5 | 1.5 | 1.5 |
| HEA | 1 | 1 | 1 | 1 | 1 | 1 | 1 | 1 |
| MW (thousand) | 1500 | 1500 | 1500 | 1500 | 1500 | 1500 | 1500 | 1500 |
| Solid Fraction (%) | 15 | 15 | 15 | 15 | 15 | 15 | 15 | 15 |
| | Curative | Curative | Curative | Curative | Curative | Curative | Curative | Curative |
| | Agent A | Agent A | Agent A | Agent A | Agent A | Agent A | Agent A | Agent A |
| Gel Fraction (%) | 65 | 65 | 65 | 65 | 65 | 65 | 65 | 65 |
| TG (° C.) | −22 | −22 | −22 | −22 | −22 | −56 | −56 | −56 |
| Refractive Index | 1.562 | 1.562 | 1.562 | 1.562 | 1.562 | 1.47 | 1.47 | 1.47 |
| (25° C.) | | | | | | | | |
| Stretch Ratio | 1.9 | 1.3 | 1.6 | 2.3 | 2.5 | 1.5 | 2 | 2.5 |
| Adhesive's | 14 | 4 | 9 | 22 | 25 | 1 | 2.2 | 4 |
| Inherent | | | | | | | | |
| Birefringence | | | | | | | | |
| (*10E−4) | | | | | | | | |
| Polarization | X | Δ | X | X | X | ◯ | ◯ | Δ |
| Distortion at the | | | | | | | | |
| time of | | | | | | | | |
| Deformation | | | | | | | | |
| Polarization | 1 | 3 | 1 | 1 | 1 | 4 | 4 | 3 |
| Distortion at the | | | | | | | | |
| time of | | | | | | | | |
| Deformation | | | | | | | | |
| (Numerical Value) | | | | | | | | |

TABLE E

| | Ex. 7-1 | Ex. 7-2 | Ex. 7-3 | Ex. 7-4 | Ex. 7-5 | Ex. 7-6 | Ex. 7-7 | Ex. 7-8 |
|---|---|---|---|---|---|---|---|---|
| | 228 | 229 | 230 | 231 | 232 | 233 | 234 | 235 |
| BA | 90 | 90 | 90 | 90 | 90 | 90 | 90 | 90 |
| MA | 10 | 10 | 10 | 10 | 10 | 10 | 10 | 10 |
| AAc | 0 | 0.5 | 0.8 | 1 | 1.18 | 1.5 | 2.5 | 4 |
| MW (thousand) | 1500 | 1500 | 1500 | 1500 | 1500 | 1500 | 1500 | 1500 |
| Solid Fraction (%) | 15 | 15 | 15 | 15 | 15 | 15 | 15 | 15 |
| | Curative | Curative | Curative | Curative | Curative | Curative | Curative | Curative |
| | Agent A | Agent A | Agent A | Agent A | Agent A | Agent A | Agent A | Agent A |
| Adhesive's | 0.09 | 0.46 | 0.62 | 0.69 | 0.77 | 1.06 | 1.69 | 2.25 |
| Inherent | | | | | | | | |
| Birefringence | | | | | | | | |
| (*10E−4) | | | | | | | | |
| Gel Fraction (%) | 72 | 84 | 88 | 81 | 96 | 91 | 82 | 94 |
| TG (° C.) | −47 | −47 | −47 | −47 | −47 | −47 | −47 | −47 |
| Refractive Index | 1.482 | 1.483 | 1.483 | 1.481 | 1.482 | 1.483 | 1.483 | 1.485 |
| (25° C.) | | | | | | | | |
| Polarization | ⊚ | ⊚ | ⊚ | ⊚ | ◯ | ◯ | ◯ | ◯ |
| Distortion at the | | | | | | | | |
| time of | | | | | | | | |
| Deformation | | | | | | | | |
| Polarization | 5 | 5 | 5 | 5 | 4 | 4 | 4 | 4 |
| Distortion at the | | | | | | | | |
| time of | | | | | | | | |
| Deformation | | | | | | | | |
| (Numerical Value) | | | | | | | | |

TABLE F

| | Ex. 8-1 | Ex. 8-2 | Ex. 8-3 | Ex. 8-4 | Ex. 9-1 | Ex. 9-2 | Ex. 9-3 | Ex. 9-4 |
|---|---|---|---|---|---|---|---|---|
| | 162 | 163 | 164 | 167 | 168 | 169 | 170 | 171 |
| BA | 100 | 100 | 100 | 100 | 100 | 100 | 100 | 100 |
| AAc | 1.5 | 1.5 | 1.5 | 1.5 | 1.5 | 1.5 | 1.5 | 1.5 |
| HEA | 1 | 1 | 1 | 1 | 1 | 1 | 1 | 1 |
| MW (thousand) | 1500 | 1500 | 1500 | 1500 | 1500 | 1500 | 1500 | 1500 |
| Solid Fraction (%) | 15 | 15 | 15 | 15 | 15 | 15 | 15 | 15 |
| Benzylbenzoate | 10 | 20 | 40 | 0 | | | | |
| Trans-Stilbene | | | | 0 | 1 | 3 | 5 | 7 |
| | Curative | Curative | Curative | Curative | Curative | Curative | Curative | Curative |
| | Agent B | Agent B | Agent B | Agent B | Agent B | Agent B | Agent B | Agent B |
| Adhesive's | −0.58 | −0.5 | −0.3 | −0.95 | −0.8 | −0.3 | −0.2 | 0.4 |
| Inherent | | | | | | | | |
| Birefringence | | | | | | | | |
| (*10E−4) | | | | | | | | |
| Gel Fraction (%) | 50 | 40 | 30 | 60 | 60 | 55 | 54 | 50 |
| TG (° C.) | −55 | −55 | −55 | −55 | −55 | −55 | −55 | −55 |
| Refractive Index | 1.472 | 1.476 | 1.483 | 1.466 | 1.468 | 1.472 | 1.476 | 1.48 |
| (25° C.) | | | | | | | | |
| Polarization | ◯ | ◯ | ◯ | ◯ | ◯ | ◯ | ◯ | ◯ |
| Distortion at the | | | | | | | | |
| time of | | | | | | | | |
| Deformation | | | | | | | | |
| Polarization | 4 | 4 | 4 | 4 | 4 | 4 | 4 | 4 |
| Distortion at the | | | | | | | | |
| time of | | | | | | | | |
| Deformation | | | | | | | | |
| (Numerical Value) | | | | | | | | |

TABLE G

| | | Ex. 10-1 | Ex. 10-2 | Ex. 10-3 | Ex. 10-4 | Ex. 10-5 |
|---|---|---|---|---|---|---|
| BA | | 100 | 100 | 100 | 100 | 100 |
| AAc | | 1.5 | 1.5 | 1.5 | 1.5 | 1.5 |
| MW (thousand) | | 1500 | 1500 | 1500 | 1500 | 1500 |
| Solid Fraction | | 15 | 15 | 15 | 15 | 15 |
| (%) | | | | | | |
| Curative Agent | Coronate | 10 | 20 | | | |
| | K\hat{ }187 | | | 10 | 20 | |
| Gel Fraction (%) | | 98 | 82 | 98 | 98 | |
| Adhesive's | | 1.06 | 10.5 | −0.38 | 0.76 | 0 |
| Inherent | | | | | | |
| Birefringence | | | | | | |
| (*10E−4) | | | | | | |
| TG (° C.) | | −55 | −55 | −55 | −55 | −55 |
| Refractive Index | | 1.471 | 1.489 | 1.471 | 1.474 | 1.466 |
| (25° C.) | | | | | | |
| Polarization | | Δ | X | ◯ | Δ | ⊚ |
| Distortion at the | | | | | | |
| time of | | | | | | |
| Deformation | | | | | | |
| Polarization | | 3 | 1 | 4 | 3 | 5 |
| Distortion at the | | | | | | |
| time of | | | | | | |
| Deformation | | | | | | |
| (Numerical Value) | | | | | | |

TABLE H
Inventive Example 12
Gel Fraction and Shrinkage Ratio
Gel Fraction and Shrinkage Ratio, Light Leakage

| | Ex. | Ex. | Ex. | Ex. | Ex. | Ex. | Ex. | Ex. | | |
|---|---|---|---|---|---|---|---|---|---|---|
| | 2-1 | 2-2 | 2-3 | 2-4 | 2-11 | 1-5 | 1-8 | 1-13 | Ex. 3 | Ex. 4 |
| Gel Fraction (%) | 92 | 92 | 92 | 92 | 65 | 65 | 65 | 65 | 30 | 0.2 |
| Shrinkage | 0.15 | 0.15 | 0.14 | 0.18 | 0.3 | 0.2 | 0.3 | 0.28 | 0.6 | 0.8 |
| Ratio (%) | | | | | | | | | | |
| Adhesive's | 6.9 | 7.8 | 8.4 | 9.2 | 2.17 | −0.65 | 0.4 | 1.98 | 0.3 | −0.27 |
| Inherent | | | | | | | | | | |
| Birefringence | | | | | | | | | | |
| (*10E−4) | | | | | | | | | | |

TABLE I

| | Ex. | Ex. | Ex. | Ex. | Ex. | Ex. | Compar. | Compar. | Compar. | Compar. |
|---|---|---|---|---|---|---|---|---|---|---|
| | 12-1 | 12-2 | 12-3 | 12-4 | 12-5 | 12-6 | Ex. 12-1 | Ex. 12-2 | Ex. 12-3 | Ex. 12-4 |
| BA | 100 | 100 | 100 | 50 | 78 | 60 | | 50 | | 80 |
| PHEA | | | | | 20 | | 100 | 50 | 100 | 20 |
| MA | | | | | | 15 | 30 | | | |
| AAc | 1.5 | 1.5 | 1.5 | 1.5 | 1.5 | 1.5 | 1.5 | 1.5 | 1.5 | 1.5 |
| HEA | 1 | 1 | 1 | 1 | 1 | 1 | 1 | | 1 | 1 |
| DMAA | | | | | | 5 | 5 | | | |
| MW (thousand) | 1500 | 1500 | 1500 | 1500 | 1500 | 1500 | 1500 | 1500 | 1500 | 1500 |
| Coronate L | 0.64 | 1 | 1.3 | 1 | 1 | 1 | 1 | 0.1 | 0.5 | 0.5 |
| Tetrad X | 0.3 | 0.5 | 0.6 | 0.6 | 0.3 | 0.3 | 0.5 | 0.1 | 0.1 | 0.1 |
| KBM-803 | 0.06 | 0.1 | 0.13 | 0.13 | 0.1 | 0.1 | 0.1 | 0.1 | 0.1 | 0.1 |
| Gel Fraction (%) | 85 | 88 | 95 | 93 | 93 | 95 | 90 | 65 | 75 | 75 |
| Adhesive's | 2.3 | 8 | 13 | 14 | 7 | 9 | 17 | 8 | 13 | 8 |
| Inherent | | | | | | | | | | |
| Birefringence | | | | | | | | | | |
| (*10E−4) | | | | | | | | | | |
| Light Leakage | ◯ | ◯ | ◯ | ◯ | ◯ | ◯ | X | X | X | X |

### Inventive Examples

Hereinafter, the present invention will be explained further in detail based on the inventive examples, but the present invention is not to be limited by these inventive examples.

### Inventive Example 1

### Production of Zero-Zero Birefringent Polymer Film

In a glass-made sample tube, there were added the total 30 g of methylmethacrylate (MMA), 2,2,2-trifluoroethylmethacrylate (3FMA) and benzylmethacrylate (BzMA); 0.5 wt % of perbutyl O (manufactured by Nippon Oil & Fats Co., Ltd.) with respect to the total amount of monomers; and 0.3 wt % of n-butylmercaptan with respect to the total amount of the monomers. The ratio (mass ratio) of the monomers was set to be MMA/3FMA/BzMA=55.5/38.0/6.5.

Those materials were stirred, dissolved and uniformed sufficiently and thereafter, were filtrated by being passed through a PTFE-made membrane filter having a hole diameter of 0.2 μm (by Toyo Roshi Kaisha, Ltd.), and were transferred to a test tube. This test tube was placed inside a water bath of 70° C. and the polymerization was applied for 24 hours. Subsequently, the heat treatment was applied for 24 hours inside a dryer of 90° C.

The polymer taken out from the test tube was put into a glass-made sample tube together with tetrahydrofuran of the amount of 4 times by the mass ratio, and was stirred and dissolved sufficiently. The obtained polymer solution was developed into a glass-late shape by using a knife coater, was left as it was for one day at the room temperature, and was dried. The formed film was peeled from the glass plate and was dried further for 48 hours at 60° C. inside a depressurized drying machine. The obtained film having thickness of approximately 35 μm was processed into a dumbbell shape and the one-axial draw was applied thereto by a tensilon universal tester (manufactured by A&D Co., Ltd.). There were set drawing temperature of 102° C., drawing speed of 400%/min and draw ratios of 1.2 to 2.7 times.

The film after being drawn was cooled up to the room temperature, it was left as it was for 24 hours at the room temperature, and thereafter, the retardation which occurred in the film was measured by using an automatic birefringence measuring apparatus ABR-10A (by Uniopt Corp., Ltd.). Further, the thickness of the film after being drawn was measured by using a micrometer. As a result thereof, the absolute value of the inherent birefringence is less than 1×10⁻⁴ in any one of the draw ratios and it was a degree in which the orientational birefringence can be regarded as zero substantially.

The photoelastic birefringence was measured with regard to the undrawn film within the aforementioned films.

The aforementioned film was cut out in a dumbbell shape as shown in FIG. 3, the tensile stress was applied to this film, and the birefringence was measured by using an automatic birefringence measuring apparatus ABR-10A (by Uniopt Corp., Ltd.). As the result of finding-out the photoelastic coefficient from the relation between the stress and the birefringence, the constant was less than 0.5×10⁻¹² Pa⁻¹ by the absolute value and it was a degree in which the photoelastic birefringence can be regarded as zero substantially.

As described above, it was confirmed that the polymer film obtained by a process as mentioned above was a zero-zero-birefringence polymer film in which either one of the orientational birefringence and the photoelastic birefringence hardly occurs.

### <Design of Adhesive Agent Using Birefringence Evaluation Method of the Present Invention>

With regard to butylacrylate (BA); ethylacrylate (EA); methylacrylate (MA) and phenoxyethylacrylate (PHEA) within the acrylates used for ordinary adhesive agents, the birefringences thereof were evaluated.

Specifically, a nitrogen gas was introduced into a reactor provided with a stirring machine, a thermometer, a reflux condenser and a nitrogen introduction tube, and the air inside this reactor was replaced by nitrogen gas. Thereafter, into this reactor, there were added 100 pts. wt of any one of BA, EA, MA and PHEA as a monomer; 100 pts. wt of ethylacetate; and acrylic acid (AAc) and hydroxyethylacrylate (HEA), whose ratios are 1.5 and 1 respectively by the mass ratios, with respect to 100 of the monomer were added inside this reactor.

Those materials were reacted for 8 hours at 60° C. in the nitrogen gas stream while being stirred and there was obtained a solution of acrylic polymer having the weight-average molecular mass of 1500 thousand. Further, a polymer solution having the solid fraction of 15 wt % was obtained by being diluted by ethylacetate. Further, the solution was made to be an adhesive agent precursor solution by compounding a curative agent A or a curative agent B, which will be described below.

### (Curative Agent)

Compound Prescription of Curative Agent A

Coronate L (manufactured by Nippon Polyurethane Industry Co., Ltd.): 1 pts. wt

Alumichelate A (manufactured by Kawaken Fine Chemicals Co., Ltd.): 0.5 pts. wt

KBM-803 (manufactured by Shinetsu Chemical Industry Co., Ltd.): 0.1 pts. wt

Compound Prescription of Curative Agent B

Coronate L: 0.1 pts. wt

Tetrad-X (manufactured by Mitsubishi Gas Chemical Co., Inc.): 0.1 pts. wt

KBM-803: 0.1 pts. wt

The obtained adhesive agent precursor solution was applied onto a film separator constituted by PET and then, was dried and thereafter, was cured by being placed in a condition of room temperature for one week. This cured film was pasted on the zero-zero-birefringence polymer film which was produced beforehand. Then, the film separator was peeled and another one sheet of zero-zero-birefringence polymer film was pasted on the aforesaid cured film on that peeled surface.

The layer-thickness of the adhesive agent was set to be approximately 30 μm, the thickness of each zero-zero-birefringence polymer film was set to be approximately 35 μm, and the whole thickness was set to be approximately 100 μm.

This laminated film was processed into a dumbbell shape shown in FIG. 3 and the one-axial draw was applied thereto by a tensilon universal tester (manufactured by A&D Co., Ltd.). There were set drawing temperature of 102° C., drawing speed of 400%/min and draw ratio of 2.0 times.

The laminated film after being drawn was cooled up to the room temperature, was left as it was for 24 hours at the room temperature, and thereafter, the retardation which occurred in the film was measured by using an automatic birefringence measuring apparatus ABR-10A (by Uniopt Corp., Ltd.).

The center portion (center portion of the region sandwiched by two gauge lines shown in FIG. 3) of the film after being drawn was solidified by being buried in an epoxy-based bonding agent and thereafter, the cross-section of the film was bared by being cut & polished and the layer-thickness of the adhesive agent was measured. The result of the measured birefringence is shown in Table 1.

TABLE 1

Birefringence (×10−4)

| Kind of Acrylate | Curative Agent A | Curative Agent B |
|---|---|---|
| PBA | 2.17 | −0.54 |
| PPHEA | 16.70 | 1.98 |
| PEA | 3.32 | −0.65 |
| PMA | 6.38 | −1.06 |

From Table 1, it is comprehended that the sign (positive or negative) and the absolute value of the birefringence, which are presented by the polymer, depend also on the kind of the curative agent. Also, it is comprehended that the magnitude of the birefringence under the same draw condition depends also on the concentration of the curative agent.

In case of using the curative agent B, there were obtained acrylates whose birefringences are positive and negative. Consequently, it is comprehended that the birefringence can be counterbalanced if the positive birefringence and the negative birefringence are combined.

It should be noted that when the gel fractions of the aforementioned obtained adhesive agents are measured separately by the abovementioned method, any one thereof was 65%.

### <Synthesis of BA/PHEA Polymer>

A copolymer between butylacrylate (BA) whose birefringence is negative and phenoxyethylacrylate (PHEA) whose birefringence is positive was synthesized by a method described below.

A nitrogen gas was introduced into a reactor provided with a stirring machine, a thermometer, a reflux condenser and a nitrogen introduction tube, and the air inside this reactor was replaced by the nitrogen gas. Thereafter, into this reactor, there were added 80 pts. wt of butylacrylate; 20 pts. wt of phenoxyethylacrylate; 1 pts. wt of acrylic acid; 0.1 pts. of azobisisobutyronitrile; and 100 pts. wt of ethylacetate. Those materials were reacted for 8 hours at 60° C. in the nitrogen gas stream while being stirred and there was obtained a solution of acrylic copolymer having the weight-average molecular mass of 1500 thousand. Further, a copolymer solution having the solid fraction of 15 wt % was obtained by being diluted by ethylacetate.

Also, the compounding ratio of the BA and the PHEA was changed from 80:20 to the ratio shown in FIG. 5 and the copolymer solution was prepared. It should be noted that the horizontal axis of FIG. 5 expresses “BA concentrations (wt %)” and this indicates a value when the total amount of the BA and the PHEA is made to be 100 wt %.

### <Measurement of Birefringence of BA/PHEA Polymer>

With regard to the solution in which the curative agent B of the aforementioned prescription was compounded with the obtained copolymer solution, the birefringence thereof was measured by the aforementioned birefringence evaluation method. The obtained result is shown in FIG. 5.

From FIG. 5, it is comprehended that the birefringence becomes approximately zero for BA/PHEA=80/20 (mass ratio). The composition ratio in which the birefringence becomes zero, which is supposed from the birefringence values in Table 1, is BA/PHEA 79/21 (mass ratio) (this is calculated as X=approximately 0.79 by equation of “−0.54X+1.98(1−X)=0”), and this was approximately the same as the designed value of the adhesive agent which there is used the birefringence evaluation method of the present invention. Consequently, there was confirmed the effectiveness of the birefringence evaluation method and the designing method & the producing method of the low-birefringent adhesive agent of the present invention.

It should be noted that when the gel fractions of the adhesive agents of the BA/PHEA polymer were measured by the abovementioned method, approximately 65% is obtained in any one of the compound ratios.

### <Evaluation of Light Leakage>

The light leakage repressing effect of these BA/PHEA copolymer-based adhesive agents was evaluated by carrying out an acceleration test such as described hereinafter.

As shown in FIG. 6, the space between a polarizing plate and a glass substrate was bonded by using a prepared BA/PHEA copolymer-based adhesive agent. This object was left as it was inside a thermostat chamber for 120 hours at 80° C. and subsequently, it was left as it was for 3 hours at 23° C. and thereafter, a combination was applied such that the polarizing plates take perpendicular positions such as shown in FIG. 6 and the light leakage was evaluated. 9-inch sized polarizing plates were used.

In FIG. 7, there are shown photographs imaging the aspects of the light leakages. The aspects of the light leakages are different in accordance with the copolymer composition ratios and the composition whose birefringence value shown in FIG. 5 is closer to zero had a fewer light leakage as much. In view of the fact that this test is an acceleration test, it is conceivable that a practical use is possible in the whole range shown in the graph of FIG. 5, but in a severer light leakage evaluation in which the result of the photographs of FIG. 7 is taken into consideration, it is preferable to employ “BA/PHEA (mass ratio)=90/10 to 70/30” and more preferable to employ “85/15 to 75/25”. In particular, on an occasion of “BA/PHEA=80/20 (mass ratio)” in which the birefringence became approximately zero, the light leakage was most reduced. From this fact, it was confirmed that the light leakage can be repressed effectively by using a low-birefringent adhesive agent obtained by the method of evaluating the birefringence and the method of designing the low-birefringent adhesive agent according to the present invention.

From those results, in order to repress the “light leakage” practically from these results, it is comprehended, in a case of the adhesive agent whose gel fraction is 65%, that it is effective to set the absolute value of the birefringence, which is evaluated and calculated under the condition of the aforementioned heat-drawing, to be 2×10⁻⁴ or less, it is more effective to set it to be 0.5×10⁻⁴ or less under the severe evaluation condition and further, it is still more effective to set it to be 0.3×10⁻⁴ or less.

### Inventive Example 2

### Production of Zero-zero Birefringent Polymer Film Having Gel Fraction of 92%

A copolymer between butylacrylate (BA) and methylacrylate (MA) was synthesized by a method described below.

A nitrogen gas was introduced into a reactor provided with a stirring machine, a thermometer, a reflux condenser and a nitrogen introduction tube, and an air inside this reactor was replaced by the nitrogen gas. Thereafter, into this reactor, there were added 80 pts. wt of butylacrylate; 20 pts. wt of methylacrylate; 3 pts. wt of acrylic acid; 0.1 pts. of azobisisobutyronitrile; and 120 pts. wt of ethylacetate. Those materials were reacted for 7 hours at 65° C. in the nitrogen gas stream while being stirred and there was obtained a solution of acrylic copolymer having the weight-average molecular mass of 800 thousand. Further, a copolymer solution having the solid fraction of 30 wt % was obtained by being diluted by ethylacetate. Thereafter, the solution was made to be an adhesive agent precursor solution 143 by compounding a curative agent C.

Compound Prescription of Curative Agent C

Coronate L (by Nippon Polyurethane Industry Co., Ltd.): 2 pts. wt

Tetrad X (by Mitsubishi Gas Chemical Co., Inc.): 0.5 pts. wt

Alumichelate A (by Kawaken Fine Chemicals Co., Ltd.): 0.5 pts. wt

KBM-403 (manufactured by Shinetsu Chemical Industry Co., Ltd.): 0.1 pts. wt

Also, adhesive agent precursor solutions 149, 150 and 151 were adjusted by changing the copolymer composition and the molecular mass respectively to ratios (mass ratios) and molecular masses, which are shown in Table 2 described below.

TABLE 2

| Adhesive-Agent | | | | |
|---|---|---|---|---|
| Precursor | | | | |
| Solution | BA | MA | PHEA | Molecular Mass |
| 143 | 80 | 20 | 0 | 800 thousand |
| 149 | 80 | 20 | 0 | 1500 thousand |
| 150 | 50 | 50 | 0 | 1500 thousand |
| 151 | 80 | 0 | 20 | 1800 thousand |

It should be noted that when the gel fractions of the aforementioned adhesive-agent polymers were measured by the abovementioned method, it was 92% for any one of the ratios or the molecular masses.

### Inventive Example 3

### Synthesis of Zero-Zero Birefringent Polymer Having Gel Fraction of 30%

A nitrogen gas was introduced into a reactor provided with a stirring machine, a thermometer, a reflux condenser and a nitrogen introduction tube, and an air inside this reactor was replaced by the nitrogen gas. Thereafter, into this reactor, there were added 80 pts. wt of butylacrylate; 20 pts. wt of methylacrylate; 1 pts. wt of hydroxyethylacrylate; 0.1 pts. of azobisisobutyronitrile; and 130 pts. wt of ethylacetate. Those materials were reacted for 7 hours at 68° C. in the nitrogen gas stream while being stirred and there was obtained a solution of acrylic copolymer having the weight-average molecular mass of 600 thousand. Further, a copolymer solution having the solid fraction of 35 wt % was obtained by being diluted by ethylacetate. Thereafter, the solution was made to be an adhesive agent precursor solution by compounding a curative agent D.

Compound Prescription of Curative Agent D

Takenate D-110N (manufactured by Mitsui Chemicals, Inc.): 0.1 pts. wt

KBM-803 (manufactured by Shinetsu Chemical Industry Co., Ltd.): 0.1 pts. wt

It should be noted that when the gel fraction of this adhesive-agent polymer was measured by the abovementioned method, it was 30%.

### Inventive Example 4

### Synthesis of Zero-Zero Birefringent Polymer Having Gel Fraction of 2%

A nitrogen gas was introduced into a reactor provided with a stirring machine, a thermometer, a reflux condenser and a nitrogen introduction tube, and an air inside this reactor was replaced by the nitrogen gas. Thereafter, into this reactor, there were added 100 pts. wt of butylacrylate; 0.1 pts. wt of 4-hydroxybutylacrylate; 0.1 pts. wt of azobisisobutyronitrile; and 150 pts. of ethylacetate. Those materials were reacted for 5 hours at 68° C. in the nitrogen gas stream while being stirred and there was obtained a solution of acrylic copolymer having the weight-average molecular mass of 400 thousand. Further, a copolymer solution having the solid fraction of 40 wt % was obtained by being diluted by ethylacetate. Thereafter, the solution was made to be an adhesive agent precursor solution 154 by compounding a curative agent E.

Compound Prescription of Curative Agent E

Takenate D-120N (manufactured by Mitsui Chemicals, Inc.): 0.01 pts. wt KBM-803 (manufactured by Shinetsu Chemical Industry Co.,

Ltd.): 0.1 pts. wt

It should be noted that when the gel fraction of this adhesive-agent polymer was measured by the abovementioned method, it was 0.2%. Further, when the birefringence of this adhesive-agent polymer was measured by the abovementioned method, it was 0.27×10⁻⁴

### Inventive Example 11

This is an inventive example utilizing a UV curing adhesive agent.

### [Copolymer Solution 1]

A nitrogen gas was introduced into a reactor provided with a stirring machine, a thermometer, a reflux condenser and a nitrogen introduction tube, and an air inside this reactor was replaced by the nitrogen gas. Thereafter, into this reactor, there were added 80 pts. of butylacrylate; 10 pts. of methylacrylate; 1.5 pts. of acrylic acid; 5 pts. of N,N-dimethylmethacrylamide; 1 pts. of hydroxyethylacrylate; 0.1 pts. of azobisisobutyronitrile; and 100 pts. of ethylacetate. Those materials were reacted for 8 hours at 68° C. in the nitrogen gas stream while being stirred and there was obtained a solution of acrylic copolymer having the weight-average molecular mass of 1500 thousand. Further, a copolymer solution 1 having the solid fraction of 20% was obtained by being diluted by ethylacetate.

<Adhesive composition, Production and Evaluation of Polarizing Plate>

With respect to 100 pts. of solid fraction of the copolymer 1, there was coated, onto a silicone-resin coated PET film, a solution formed by mixing 10 pts. of 2-hydroxy-3-phenoxypropylacrylate (mono functional acrylate); 20 pts. of di(tri)acryloxyethylisocyanurate (multi functional crylate); 2.9 pts. of β-carboxyethylacrylate (mono functional acrylate); 0.64 pts. of 2,4,6-trimethylbenzoylethoxyphosphineoxide (photopolymerization initiator); 2.7 pts. of trimethylolpropanetris (3-mercaptopropionate); and 0.1 pts. of silane-coupling agent (methylmercapto-based alkoxyoligomer) and thereafter, the solvent thereof was removed by being dried at 90° C. and an adhesive agent layer whose thickness was 25 μm was formed. The surface, on which this adhesive agent layer was formed, was bonded with a polarizing plate (EWV) whose thickness was 180 μm by applying an ultraviolet-crosslink under a condition described below. With regard to the ultraviolet curing condition, the irradiation was applied under a condition of the light-amount of 200 mJ/cm by using an electrodeless-lamp D-bulb manufactured by Fusion Lighting Corporation. A “UV power pack” manufactured by EIT, Inc. was used for the illuminance & action meters.

The gel fraction of the adhesive composition in the inventive example, which was obtained by the aforementioned method, was 76%, the refractive index thereof was 1.483 and the adhesive agent inherent birefringence thereof was 1.7×10⁻⁴, and the distortion of polarization state at the time of deformation was preferable (o).

### Inventive Example 12

As the result in which the shrinkage ratios of the adhesive agents used in the inventive examples 1 to 4 were measured in accordance with the shrinkage ratio measurement method and the relation with respect to the gel fractions was found out, it was comprehended that the larger the gel fraction was, the smaller the shrinkage ratio was. This phenomenon is shown in FIG. 16.

The adhesive agent, in which the gel fraction and the adhesive's inherent birefringence were changed, was processed on the polarizing plate and the test of the light leakage was carried out. This result is shown in FIG. 17. The symbols “o” in FIG. 17 indicate the adhesive agents in which white spots were not observed on the polarizing plates in the evaluation of the light leakage and the symbols “” indicate the adhesive agents in which white spots were observed thereon.

### Inventive Example 13

As the result of observing a laminated film after being drawn twice, in which the zero birefringent adhesive agent (inventive example 3) having thickness of 175 μm was laminated onto the zero-zero birefringence polymer (described in Inventive Example 1), by using a polarization strain gauge, the distortion of polarization state was preferable. Similarly, the distortion of polarization state of an adhesive agent after being drawn twice, in which the adhesive agent (Inventive Example 2-2) of 175 μm having a large birefringence was bonded together, was observed very largely.

### Inventive Example 14

This example is an inventive example of an adhesive agent which can be substitutional for the polarizer protection film.

### Reference Example

### Production of Polyvinylalcohol-based Polarizer Film (1)

A polyvinylalcohol film having thickness of 80 μm, whose degree of saponification is 99.7%, was one-axially drawn (draw ratio is five times), in which this film was soaked into an iodine and potassium iodide water solution while maintaining a strain state, and subsequently, a polyvinylalcohol-based polarizer film (1) was obtained after carrying out a treatment by a boric acid water solution, water-washing and drying.

### Inventive Example 14-1

The polarizing film (1) (thickness: 18-m) obtained by the reference example 1 was bonded with a triacetylcellulose film (Fuji TAC UV80) having thickness of 80 μm as a polarizer protection film (2) by using 5 wt. % water solution of polyvinylalcohol (Kuraray-poval 217) as a bonding agent (3) and this was dried for 20 minutes at 60° C.

The adhesive agent (inventive example 1-8) was applied & dried on a release film (4) (36 micron PET release film manufactured by Mitsubishi Chemical: MRF35) such that the thickness of the agent becomes 25 μm and this was bonded onto the side of the aforementioned polarizer film.

### Inventive Example 14-2

On both the sides of polarizing film (1) (thickness: 18 μm) obtained by the reference example 1, there were bonded films each of which was formed by being applied with & drying the adhesive agent (inventive examples 1-8) on the release film (4) such that the thickness thereof becomes 25 μm. One side of these release films was peeled and a phase-difference film (6) was bonded thereon.

### Comparative Example

By using a similar material as that of the inventive example 1, triacetylcellulose films (Fuji TAC UV80) having thicknesses of 80 μm were bonded on both the sides of the polarizer film, and the adhesive agent (inventive example 10-2) was applied & dried on the release film (4) such that the thickness of the agent becomes 25 μm and this was bonded on one side of the aforementioned polarizing plate.

For the comparison, evaluations of the bends of these polarizing plates, peeling of the release film, the durability and the light leakage were carried out. The evaluation results of the inventive examples 14-1 and 14-2 were preferable for all the items, but in the comparative example, the light leakage was not excellent.

### Inventive Example 15

This example is an inventive example regarding a combination of the zero birefringent adhesive agent and the zero-zero birefringent film.

As the result when the laminated material formed by the zero-zero birefringence polymer (inventive example 1) and the zero birefringent adhesive agent (inventive example 3) after being drawn twice was observed by a distortion of polarization state meter, it was recognized that the distortion of polarization state is preferable. The distortion of polarization state of a film after being drawn twice, in which the adhesive agent (inventive example 2) whose birefringence is large is bonded with 25 μm polyester film (large birefringence), was observed very largely.

### <Test Method and Evaluation Criteria>

Here, there will be explained a test method and an evaluation criteria newly again.

### [Gel Fraction]

The adhesive agent film after being crosslinked was weight-measured by 0.2 g (W1) accurately and was soaked into toluene 50 ml during one day and thereafter, a woven metal wire having 200-mesh was weight-measured (W2). Next, filtration was carried out and there was extracted a soluble portion. Thereafter, the drying was applied and the weight of the insoluble portion (W3) was found out. Based on those measurement values, the gel fraction (Wt %) was calculated by using the following formula. Gel Fraction (Wt %)=((W3−W2)/W1)×100

### [Measurement Method of Glassy-Transition Temperature (Tg)]

With regard to the film after being crosslinked, Tg thereof was measured by using a DSC thermal analysis apparatus.

### [Light Leakage]

Identical two sheets of samples after carrying out the endurance test at 80° C., in which the polarizing plates in the inventive example and the comparative example were used, were bonded on the top & bottom surfaces of the liquid crystal panel by using a cross-nicol configuration, and the states of white spots were observed by eyesight by turning-on the backlight of the liquid crystal monitor.

The evaluation criteria is as follows.

o: White spots were not observed on the polarizing plate.
Δ: White spots were observed slightly on the polarizing plate.
x: White spots were observed on the polarizing plate.

### [Weight-Average Molecular Mass (Mw)]

This is a polystyrene converted molecular mass measured by a GPC (GEL Permeation Chromatography) method. In detail, a coating film obtained by drying a copolymer at normal temperature was dissolved into tetrahydrofuran, was measured by a high-performance liquid chromatography (manufactured by Shimadzu Corporation, LC-10ADvp, Column KF-G+KF-806×2), and there was found out the weight-average molecular mass (Mw) by the polystyrene conversion.

### [Shrinkage Ratio]

It is possible for the shrinkage ratio in a state of being bonded on the glass plate according to the present invention to be found out by a method shown in the following description. An adhesive agent solution is coated onto a polyester separation film (38 μm) such that the thickness of the dried coating film becomes 25 μm, is dried for 60 seconds at 90° C., and is transcribed on a polarizing plate, whereby a polarizing plate sample is obtained by taking care of it for 7 days in the atmosphere of 65% RH at 23° C. The sample, in which the obtained polarizing plate sample is cut to be the length of 80 mm×150 mm such that an absorption axis thereof becomes 45 with respect to the long side of the polarizing plate, is made to be a test sample. The aforementioned polarizing plate sample is bonded on one side of the glass plate through the adhesive agent by applying pressure of 5 Kg/cm² in a condition of 50° C. and by maintaining that state for 18 minutes, whereby the sample is made to be a test sample. The length (L1) of the diagonal line in the absorption-axis direction of the aforesaid test sample is measured by a reading-microscope (manufactured by Nippon Optical Works CO., LTD). After the measurement and after leaving the test sample as it is for 24 hours at 90° C., the length (L2) of the diagonal line immediately after the sample is taken out is measured.

The Shrinkage Ratio (%) in a state of being bonded on the glass plate is as follows:

Shrinkage Ratio(%)=(L1−L2)/L1×100.

### [Polarization Distortion at the Time of Deformation]

According to the manner of the inventive example 1, with regard to the sample formed by laminating the zero-zero-birefringence polymer films in which the adhesive agent is drawn twice, the situation of the light leakage thereof is observed by a distortion of polarization state meter (crossed-nicols).

Since the light leakage does not occur at all for the zero-zero-birefringence polymer film alone, it is conceivable that this light leakage is caused by the adhesive agent. Also, the thickness of the adhesive agent after being drawn was adjusted so as to become approximately 20 μm.

Evaluation examples are as follows.

There was employed digitalization such as ⊚: 5, o: 4, Δ: 3 and x: 1.

An evaluation example of the light strain is shown in FIG. 15.

As described above, there has been explained the present invention while referring to specific exemplified examples. However, it is evident that a person skilled in the art can employ an amendment or a substitution of the exemplified example within the scope without departing from the gist of the present invention. More specifically, the present invention has been disclosed by a form such as an exemplification, and it should not be allowed to interpret the described contents of the present specification in a limited way. In order to judge the gist of the present invention, the columns of the patent claims should be taken into consideration.

Also, it is clear that the exemplified examples for explaining this invention will achieve the above-mentioned purposes, but it is to be understood that a person skilled in the art can employ many changes and/or other practical examples. It is also allowed for the element or the component in the patent claims, in the specification, in the drawings and in each exemplified example for explanation to be employed together with another one or by a combination thereof. The scope of the patent claims is intended to include such a change and another exemplified example in that scope and those are included in the technical concept and the technical scope of the present invention.

1. A method of evaluating birefringence of an adhesive agent comprising:
preparing a laminated film by applying an adhesive agent to a support body which comprises a polymer film whose inherent birefringence is 1×10⁻³ or less;
heat-drawing said laminated film; and
measuring retardation of the laminated film after being heat-drawn and the layer-thickness of said adhesive agent.

2. The method of evaluating birefringence according to claim 1, wherein for said polymer film, the photoelastic coefficient thereof is 1×10⁻¹² Pa⁻¹ or less by the absolute value.

3. The method of evaluating birefringence according to claim 1, wherein said laminated film is a laminated film formed by sandwiching said adhesive agent between said two sheets of support bodies.

4. The method of evaluating birefringence according to a claim 1, wherein said heat-drawing is carried out under a glass-transition temperature or more of said polymer film.

5. The method of evaluating birefringence according to claim 1, wherein said heat-drawing is carried out under a condition of 70° C. to 150° C. drawing temperature, 50%/min to 1000%/min drawing speed and draw ratio of 1.1 times to 3 times.

6. A method of designing an adhesive agent comprising:
measuring birefringences of plural kinds of adhesive polymer compositions which include polymers and which are used for samples by for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units and for determining the polymer structure based on said obtained birefringence value for every of the repeating units, and
applying said determined polymer to the adhesive agent.

7. The method of designing an adhesive agent according to claim 6, wherein a repeating unit in which said birefringence value indicates a negative value and a repeating unit in which said birefringence value indicates a positive value are combined in the process for determining the combination and the combination ratio of said repeating units and for determining the polymer structure.

8. The method of designing an adhesive agent according to claim 6 further comprising adjusting the birefringence value by compounding an addition agent or a curative agent.

9. The method of designing an adhesive agent according to claim 6, wherein
in case of applying a polymer, whose gel fraction expressed by
[gel fraction(%)]=[mass of insoluble portion(g)]×100/[mass of adhesive agent(g)]
is 0.1% or more and less than 80%, to the adhesive agent,
heat-drawing in said birefringence evaluation method is carried out by drawing temperature of 102° C., by drawing speed of 400%/min and by draw ratio of twice, and the combination and the combination ratio of said repeating units are determined such that the absolute value of the birefringence obtained by adding, in response to the combination ratio, the birefringence value for every of said repeating units, which were obtained at that time, becomes 4×10⁻⁴ or less, whereby the polymer structure is determined.

10. The method of designing an adhesive agent according to claim 6, wherein
in case of applying a polymer, whose gel fraction expressed by
[gel fraction(%)]=[mass of insoluble portion(g)]×100/[mass of adhesive agent(g)]
is 80% or more, to the adhesive agent,
heat-drawing in said birefringence evaluation method is carried out by drawing temperature of 102° C., by drawing speed of 400%/min and by draw ratio of twice, and the combination and the combination ratio of said repeating units are determined such that the absolute value of the birefringence obtained by adding, in response to the combination ratio, the birefringence value for every of said repeating units, which were obtained at that time, becomes 15×10⁻⁴ or less, whereby the polymer structure is determined.

11. A method of producing an adhesive agent comprising:
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent.

12. The method of producing an adhesive agent according to claim 11, wherein a repeating unit in which said birefringence value indicates a negative value and a repeating unit in which said birefringence value indicates a positive value are combined in the process for determining the combination and the combination ratio of said repeating units.

13. The method of producing an adhesive agent according to claim 11 further comprising adjusting the birefringence value by compounding an addition agent or a curative agent.

14. An adhesive agent produced by a method comprising:
measuring birefringences of plural kinds of adhesive polymer compositions which include polymers and which are used for samples by for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent.

15. An adhesive agent produced by a method comprising:
measuring birefringences of plural kinds of adhesive polymer compositions which include polymers and which are used for samples by, for each adhesive polymer composition,
preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein a repeating unit in which said birefringence value indicates a negative value and a repeating unit in which said birefringence value indicates a positive value are combined in the step of determining the combination and the combination ratio of said repeating units.

16. The adhesive agent of claim 15 wherein the method further comprises adjusting the birefringence value by compounding an addition agent or a curative agent.

17. The method of claim 11, wherein
in case of applying a polymer, whose gel fraction expressed by
[gel fraction(%)]=[mass of insoluble portion(g)]×100/[mass of adhesive agent(g)]
is 0.1% or more and less than 80%, to the adhesive agent,
heat-drawing in said birefringence evaluation method is carried out by drawing temperature of 102° C., by drawing speed of 400%/min and by draw ratio of twice, and the combination and the combination ratio of said repeating units are determined such that the absolute value of the birefringence obtained by adding, in response to the combination ratio, the birefringence value for every of said repeating units, which were obtained at that time, becomes 4×10⁻⁴ or less.

18. The method of claim 11, wherein
in case of applying a polymer, whose gel fraction expressed by
[gel fraction(%)]=[mass of insoluble portion(g)]×100/[mass of adhesive agent(g)]
is 0.1% or more and less than 80%, to the adhesive agent,
said heat-drawing is carried out by drawing temperature of 102° C., by drawing speed of 400%/min and by draw ratio of twice, and the combination and the combination ratio of said repeating units are determined such that the absolute value of the birefringence obtained by adding, in response to the combination ratio, the birefringence value for every of said repeating units, which were obtained at that time, becomes 15×10⁻⁴ or less.

19. An adhesive agent obtained by
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein the absolute value of the birefringence obtained when carrying out the heat-drawing by drawing temperature of 102° C., by drawing speed of 400%/min and by draw ratio of twice is 4×10⁻⁴ or less, and the gel fraction is 0.1% or more and less than 80%.

20. An adhesive agent obtained by
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein the absolute value of the birefringence obtained when carrying out the heat-drawing by drawing temperature of 102° C., by drawing speed of 400%/min and by draw ratio of twice is 15×10⁻⁴ or less, and the gel fraction is 80% or more.

21. A method of producing a polarizing plate comprising bonding a polarizing film and a glass substrate together by using an adhesive agent obtained by the method according to claim 11.

22. A method of producing a liquid crystal display device including a backlight, a liquid crystal layer, and a polarizing plate having a polarizing film and a glass substrate, comprising a process for bonding said polarizing film and said glass substrate together by using an adhesive agent obtained by the method according to claim 11.

23. A polarizing plate, comprising a polarizing film and a glass substrate that are bonded together by an adhesive agent obtained by
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein the absolute value of the birefringence obtained when carrying out the heat-drawing by drawing temperature of 102° C., by drawing speed of 400%/min and by draw ratio of twice is 4×10⁻⁴ or less, and the gel fraction is 0.1% or more and less than 80%.

24. A liquid crystal display device comprising a backlight, a liquid crystal layer, a polarizing plate having a polarizing film and a glass substrate, wherein said polarizing film and said glass substrate are bonded together by an adhesive agent obtained by
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions.
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein the absolute value of the birefringence obtained when carrying out the heat-drawing by drawing temperature of 102° C., by drawing speed of 400%/min and by draw ratio of twice is 4×10⁻⁴ or less, and the gel fraction is 0.1% or more and less than 80%.

25. An adhesive agent, wherein the absolute value of the adhesive's inherent birefringence which is obtained by the method of claim 5 is 4×10⁻⁴ or less.

26. An adhesive agent, wherein the absolute value of the adhesive's inherent birefringence which is obtained by the method of claim 5 is 2×10⁻⁴ or less.

27. An adhesive agent, wherein the absolute value of the adhesive's inherent birefringence which is obtained by the method of claim 9 is 4×10⁻⁴ or less.

28. An adhesive agent, wherein the absolute value of the adhesive's inherent birefringence which is obtained by the method of claim 9 is 2×10⁻⁴ or less.

29. A polarizing plate comprising an adhesive agent according to claim 25.

30. An adhesive agent obtained by the method of claim 10 in which the gel fraction is 80% or more and the absolute value of the adhesive's inherent birefringence is 15×10⁻⁴ or less.

31. The adhesive agent according to claim 30, wherein the gel fraction thereof is 85% or more.

32. A method of evaluating birefringence of an adhesive agent comprising:
drawing the adhesive agent which lies on a polymer film together with the polymer film and for forming a drawn film;
measuring retardation of said drawn film; and
measuring layer-thickness of said adhesive agent, wherein
the birefringence is found by dividing said retardation by said thickness.

33. A method of evaluating birefringence of an adhesive agent comprising:
drawing a sample obtained by sandwiching the adhesive agent between two sheets of polymer films;
measuring retardation inside the film surface of said polymer film; and,
measuring layer-thickness of said adhesive agent; wherein
the birefringence is found by dividing said retardation by said thickness.

34. A polarizing plate, comprising at least one film selected from the group consisting of a polarizing-plate protection film in which the absolute value of the photoelastic coefficient is 8×10⁻¹² Pa⁻¹ or less, or a phase-difference film in which the absolute value of the photoelastic coefficient is 8×10⁻¹² Pa⁻¹ or less,
and wherein the polarizing plate is bonded with an adhesive agent produced by a method comprising:
measuring birefringences of plural kinds of adhesive polymer compositions which include polymers and which are used for samples by, for each adhesive polymer composition,
preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein a repeating unit in which said birefringence value indicates a negative value and a repeating unit in which said birefringence value indicates a positive value are combined in the step of determining the combination and the combination ratio of said repeating units; and,
wherein the birefringence value is adjusted by compounding an addition agent or a curative agent.

35. A method of designing an adhesive agent comprising:
obtaining the birefringence value of an adhesive polymer composition including at least one of an addition agent and a curative agent, and a polymer by preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent; and
determining the ratio between the polymer and the compound material based on the birefringence value of said polymer composition and for applying it to the adhesive agent.

36. A method of producing an adhesive agent comprising:
obtaining the birefringence value of an adhesive polymer composition including at least one of an addition agent and a curative agent, and a polymer by preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent; and
determining the ratio between the polymer and the compound material based on the birefringence value of said polymer composition and for applying it to the adhesive agent.

37. An adhesive agent produced by:
obtaining the birefringence value of an adhesive polymer composition including at least one of an addition agent and a curative agent, and a polymer by preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent; and
determining the ratio between the polymer and the compound material based on the birefringence value of said polymer composition and for applying it to the adhesive agent.

38. The method of claim 8, wherein said addition agent is a compound including at least two pieces of aromatic rings inside the molecule.

39. The method of claim 13, wherein said addition agent is a compound including at least two pieces of aromatic rings inside the molecule.

40. The adhesive agent according to claim 37, wherein said addition agent is a compound including at least two pieces of aromatic rings inside the molecule.

41. An adhesive agent, wherein the absolute value of the adhesive's inherent birefringence which is obtained by the method of evaluating birefringence according to claim 5 is 15×10⁻⁴ or less and the gel fraction is 80% or more.

42. The method of claim 35, wherein said addition agent is a compound including at least two pieces of aromatic rings inside the molecule.

43. The method of claim 36, wherein said addition agent is a compound including at least two pieces of aromatic rings inside the molecule.

44. A method of producing an adhesive agent comprising:
measuring birefringences of plural kinds of adhesive polymer compositions which include polymers and which are used for samples by, for each adhesive polymer composition,
preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein a repeating unit in which said birefringence value indicates a negative value and a repeating unit in which said birefringence value indicates a positive value are combined in the step of determining the combination and the combination ratio of said repeating units;
wherein the birefringence value is adjusted by compounding an addition agent or a curative agent; and,
wherein said addition agent is a compound including at least two pieces of aromatic rings inside the molecule.

45. A polarizing plate, comprising a polarizing film and a glass substrate that are bonded together by An adhesive agent obtained by
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein the absolute value of the birefringence obtained when carrying out the heat-drawing by drawing temperature of 102° C., by drawing speed of 400%/min and by draw ratio of twice is 15×10⁻⁴ or less, and the gel fraction is 80% or more.

46. A liquid crystal display device comprising a backlight, a liquid crystal layer, a polarizing plate having a polarizing film and a glass substrate, wherein said polarizing film and said glass substrate are bonded together an adhesive agent obtained by
measuring birefringences of plural kinds of adhesive polymer compositions which include polymers and which are used for samples by, for each adhesive polymer composition, preparing a laminated film by applying the adhesive agent to a support body which comprises a polymer film whose inherent birefringence is 1×10⁻³ or less, heat-drawing said laminated film, and measuring retardation of the laminated film after being heat-drawn and the layer-thickness of said adhesive agent;
calculating birefringence corresponding to each repeating unit in said polymers from the values of said birefringences of said polymer compositions,
determining the combination and the combination ratio of the repeating units based on said obtained birefringence value for every of the repeating units,
synthesizing a polymer by polymerizing monomers corresponding to said repeating units by said determined ratio, and
applying said synthesized polymer to the adhesive agent;
wherein the absolute value of the birefringence obtained when carrying out the heat-drawing by drawing temperature of 102° C., by drawing speed of 400%/min and by draw ratio of twice is 15×10⁻⁴ or less, and the gel fraction is 80% or more.
